(19) United States
(12) Patent Application Publication
(10) Pub. No.: US 2006/0153172 A1
(43) Pub. Date: Jul. 13, 2006

(54) Emergency call system and emergency call method

(75) Inventors: Katsuhiko Yamada, Kanagawa (JP); Azuma Tsubota, Tokyo (JP)

Correspondence Address: VENABLE LLP, P.O. BOX 34385, WASHINGTON, DC, 20045-9998, US

(73) Assignee: Oki Electric Industry Co., Ltd., Tokyo (JP)

(21) Appl. No.: 11/325,577

(22) Filed: Jan. 5, 2006

(30) Foreign Application Priority Data
Jan. 7, 2005 (JP) 2005-002779
Jan. 24, 2005 (JP) 2005-015919

(51) Int. Cl. H04L 12/66; H04Q 7/20

(52) U.S. Cl. 370/352; 455/456.1

(57) ABSTRACT

An emergency call system includes a position information management device and a position information notification device, wherein the position information management device includes a first management section which manages first terminal information and first position information of a terminal and a first processing section which receives the first terminal information and transmits the first position information to the position information notification device, wherein the position information notification device includes a second management section which manages the first terminal information and first address information of the position information management device and a second processing section which receives the first terminal information from a first device, transmits the first terminal information of the position information management device on the basis of the first address information, receives the first position information from the position information management device, and transmits the first position information to the first device.

### BACKGROUND OF THE INVENTION

1. Field of the Invention

The present invention relates to an emergency call system and an emergency call method for specifying a position of a terminal when a caller makes an emergency call to the police, fire fighters or the like from the terminal.

2. Description of the Related Art

Phone services in conventional Public Switched Telephone Networks (PSTN) are now growing into Internet Protocol (IP) phone services which offer a phone service on an IP network such as the Internet. Wireless IP phone services which offer IP phone from wireless LAN terminals are also beginning to appear. Phone services are required not only for communications in everyday life but also for providing lifeline services such as emergency calls as part of the social infrastructure. In the non-patent document 1, one of the basic functions of emergency calls is to manage a caller's position information. The caller's position information is required to connect the caller's terminal to a command system in a head office having jurisdiction over an area where the caller makes an emergency call, or to specify the caller's position so that police or other officers can rush to the scene. The non-patent document 1 is “A method of securing an important communication such as an emergency call in an IP network, Interim Report (summary)” issued on Sep. 22, 2004, by IP Phone Working Party, Committee for Developing an Emergency Call Function etc., Information and Communications Technical Subcommittee, Information and Communications Emergency Council, Ministry of Internal Affairs and Communications.

FIG. 1 is a block diagram showing a configuration including an emergency call system disclosed in the non-patent document 1 when the position of an IP phone terminal is fixed. The subscriber's phone number and address information are registered in a subscriber information database 123 in a Voice over Internet Protocol (VoIP) network 102 provided by the IP phone service company or the like. The address information and phone numbers of emergency call receiving organizations such as the police which have jurisdiction over an addresses included in the address information, are registered in a connection destination information database 124. When an emergency call number is dialed from an IP phone terminal 111 in an access network 101, a call control server 121 in the VoIP network 102 acquires the address information of the caller from the subscriber information database 123, acquires the phone number of the emergency call receiving organization 103 from the connection destination information database 124, and connects to a command terminal 131 of the command system in the emergency call receiving organization 103. When the emergency call receiving organization 103 wishes to acquire the caller's position information, a position information receiver 132 of the command system in the emergency call receiving organization 103 issues an inquiry to a position information notification server 122 by a message containing the caller's phone number. The position information notification server 122 retrieves address information from the subscriber information database 123 and returns a result of the retrieval to the position information receiver 132. The aforesaid method makes it possible to attain a position information management function which the emergency call system should have.

However, in the aforesaid prior art, although a position information management framework was provided for fixed IP phone terminals and the fixed IP phone terminals can be transferred (or relocated) by changing the IP address of the IP phone terminal, it was difficult to change the IP address information in the subscriber information database 123 for every such relocation. Also, in the aforesaid prior art, although a position information management framework was provided for fixed IP phone terminals, wireless IP phone terminal stations can move freely, and the position information management method which made use of prior registration information could not adapt to the case where the caller's position was not fixed. A Global Positioning System (GPS) function has been implemented on a cellular phone network which can pinpoint the position of a moving terminal, but it cannot be used in an underground center without a cellular phone network, nor can it discriminate differences of height, such as the different levels of a building. Moreover, for wireless IP phone terminal stations, in addition to shared cellular phone terminals, various types of terminals are being considered such as a softphone implemented by software on a notebook PC, and it is difficult to imagine that all these terminals will have a GPS function.

### SUMMARY OF THE INVENTION

It is an object of the present invention to provide an emergency call system and an emergency call method for specifying a position of a terminal when a caller makes an emergency call to the emergency call receiving organization from the terminal.

According to one aspect of the present invention, an emergency call system includes a position information management device and a position information notification device. The position information management device includes a first management section which manages first terminal information of a terminal and first position information of the terminal, and a first processing section which receives the first terminal information transmitted from the position information notification device, and transmits the first position information to the position information notification device. The position information notification device includes a second management section which manages the first terminal information and first address information of the position information management device, and a second processing section which receives the first terminal information from a first device, transmits the first terminal information of the position information management device on the basis of the first address information, receives the first position information from the position information management device, and transmits the first position information to the first device.

According to another aspect of the present invention, an emergency call method using a position information management device and a position information notification device, including the steps of: causing the position information management device to manage first terminal information of a terminal and first position information of the terminal; and causing the position information management device to receive the first terminal information transmitted from the first position information notification device and to transmit the first position information to the position information notification device; causing the position information notification device to manage the first terminal information and first address information of the position information management device; and causing the position information notification device to receive the first terminal information from the first terminal, to transmit the first terminal information to the position information management device on the basis of the first address information, to receive the first position information from the position information management device, and to transmit the first position information to a first device.

According to a further aspect of the present invention, an emergency call system includes: a position information management device; a call control device; and a position information notification device. The position information management device includes a first management section which manages the first terminal information of a terminal and the first position information of the terminal, and a first processing section which receives the first terminal information transmitted from the position information notification device, and transmits the first position information to the position information notification device. The call control device retrieves the first terminal information from a received second terminal information of the terminal, and transmits the retrieved first terminal information. The position information notification device includes a second management section which manages the first terminal information and first address information of the position information management device, and a second processing section which receives the second terminal information from a command system placed in an emergency call receiving organization, transmits the second terminal information to the call control device, receives the first terminal information from the call control device, transmits the first terminal information to the position information management device on the basis of the first address information, receives the first position information from the position information management device, and transmits the first position information to a first device.

According to a yet further aspect of the present invention an emergency call system includes: a position information management device and a position information notification device. The position information management device includes a first management section which manages first terminal information of a terminal and first position information of the terminal, and a first processing section which receives the first terminal information transmitted from the position information notification device, and transmits the first position information to the position information notification device. The position information notification device includes a second management section which manages network address information of first address information of the position information management device, and the first address information of the position information management device; and a second processing section which receives first terminal information from a command system placed in an emergency call receiving organization, retrieves the network address information of the first address information which indicates with a network address of the first terminal information, transmits the first terminal information to the position information management device on the basis of the retrieved address information, receives the first position information from the position information management device, and transmits the first position information to a first device.

According to a yet further aspect of the present invention, an emergency call method using a position information management device, a call control device, and a position information notification device, includes the steps of: causing the position information management device to manage first terminal information of a terminal and first position information of the terminal; causing the position information management device to receive the first terminal information transmitted from the first position information notification device and to transmit the first position information to the position information notification device; causing the call control device to retrieve the first terminal information from a received second terminal information and to transmit the retrieved first terminal information; causing the position information notification device to manage the first terminal information and first address information of the position information management device; and causing the position information notification device to receive the second terminal information from a command system placed in an emergency call receiving organization, transmits the second terminal information to the call control device, to receive the first terminal information from the call control device, to transmit the first terminal information to the position information management device on the basis of the first address information, to receive the first position information from the position information management device, and to transmit the first position information to a first device.

According to a yet further aspect of the present invention, an emergency call method using a position information management device and a position information notification device, includes the steps of: causing the position information management device to manage first terminal information of a terminal and first position information of the terminal; causing the position information management device to receive the first terminal information transmitted from the position information notification device and to transmit the first position information to the position information notification device; causing the position information notification device to manage the first terminal information and first address information of the position information management device; and causing the position information notification device to receive a second terminal information from a command system placed in an emergency call receiving organization, to transmit the first terminal information to the position information management device on the basis of the first address information, to receive the first position information from the position information management device, and to transmit the first position information to a first device.

According to the emergency call system or emergency call method of the present invention, it is possible to provide a framework which can acquire position information about a relocatable terminal or a mobile terminal and reply to inquiries about terminal position from a command system in an emergency call receiving organization having jurisdiction over the terminal, and can connect the terminal to the nearest emergency call receiving organization. Moreover, according to the emergency call system or emergency call method of the present invention, even when a terminal as a wireless terminal station moves to a different wireless service area, since the position information management device is specified from terminal address information when a call is made, the present terminal position information can be acquired.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram showing a configuration including an emergency call system of the prior art;

FIG. 2 is a block diagram showing a configuration including an emergency call system according to the first embodiment of the present invention;

FIG. 3 is a diagram describing the operation of the emergency call system according to the first embodiment;

FIG. 4 is a block diagram showing a configuration including an emergency call system according to the second embodiment of the present invention;

FIG. 5 is a diagram describing the operation of the emergency call system according to the second embodiment;

FIG. 6 is a block diagram showing a configuration including an emergency call system according to the third embodiment of the present invention;

FIG. 7 is a diagram describing the operation of the emergency call system according to the third embodiment;

FIG. 8 is a block diagram showing a configuration including an emergency call system according to the fourth embodiment of the present invention; and

FIG. 9 is a diagram describing the operation of the emergency call system according to the fourth embodiment.

### DETAILED DESCRIPTION OF THE INVENTION

Further scope of applicability of the present invention will become apparent from the detailed description given hereinafter. However, it should be understood that the detailed description and specific examples, while indicating preferred embodiments of the invention, are given by way of illustration only, since various changes and modifications will become apparent to those skilled in the art from the detailed description.

### <A> First Embodiment

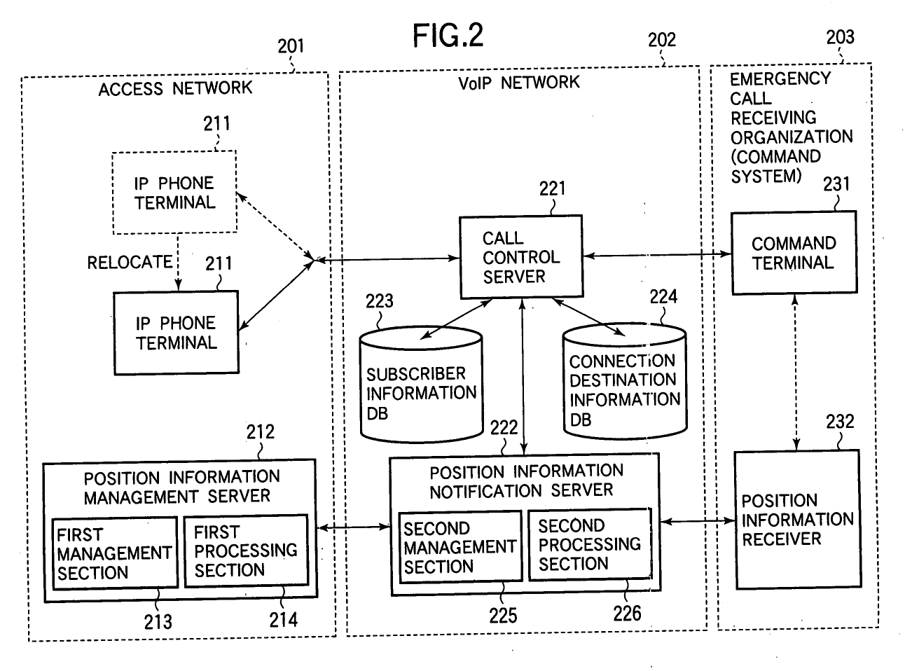

The first embodiment of the present invention will be described below in detail referring to the drawings. FIG. 2 is a block diagram showing a configuration including an emergency call system according to the first embodiment of the present invention.

Referring to FIG. 2, an access network 201 includes an IP phone terminal 211 and a position information management server 212. The access network 201 can include one or more IP phone terminals other than the IP phone terminal 211, but the IP phone terminals other than the IP phone terminal 211 are not shown in FIG. 2. Further, there may also be one or more other access networks other than the access network 201, but the access networks other than the access network 201 are not shown in FIG. 2.

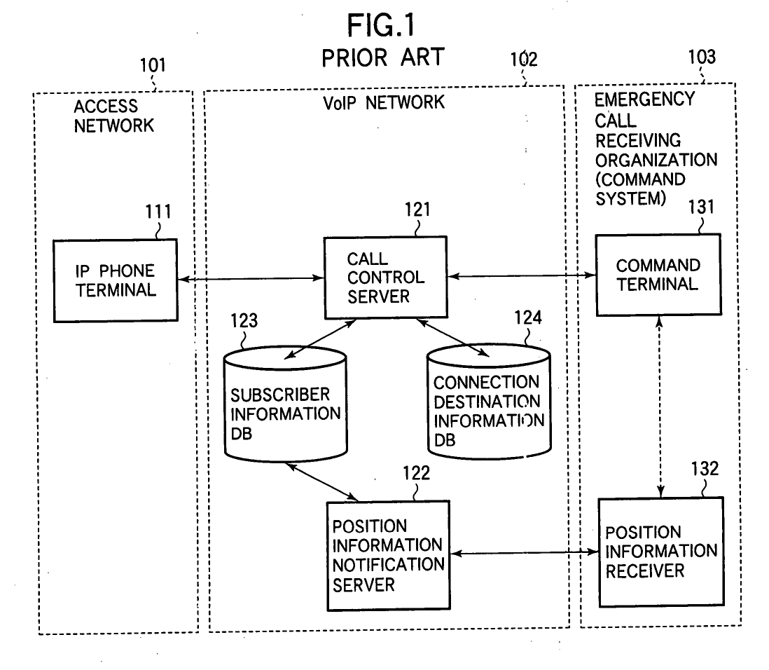

The IP phone terminal 211 shown in FIG. 2 basically has the same configuration as the IP phone terminal 111 shown in FIG. 1.

The position information management server 212 manages first position information of the IP phone terminal 211 correspondingly to first terminal information of the IP phone terminal 211. The first terminal information of the IP phone terminal 211 is, for example, an Internet Protocol (IP) address of the IP phone terminal 211 or a Session Initiation Protocol-Uniform Resource Identifier (SIP-URI) of the user who owns the IP phone terminal 211. SIP is a protocol specified by, for example, Requests for Comments (RFC) 3261 issued by the Internet Engineering Task Force (IETF), and SIP-URI notation may, for example, consist of a domain name part and a local part. The position information management server 212 also manages one or more IP phone terminals other than the IP phone terminal 211, and manages position information of each of these other IP phone terminals correspondingly to the terminal information of each of these other IP phone terminals.

Referring to FIG. 2, the position information management server 212 includes a first management section 213 which manages the first terminal information of the IP phone terminal 211 and the first position information of the IP phone terminal 211, and a first processing section 214 which receives the first terminal information transmitted from a position information notification server 222, which will be described later, and transmits the first position information to the position information notification server 222. The first position information is registered on the basis of the position of the installed IP phone terminal 211, the position of the transferred (or relocated) IP phone terminal 211 and the like, and managed correspondingly to the first terminal information. The first management section 213 manages one or more IP phone terminals other than the IP phone terminal 211 in a similar manner. The first processing section 214 performs processing for one or more IP phone terminals other than the IP phone terminal 211 in a similar manner.

The position information management server 212 is managed by an operational manager of a Local Area Network (LAN) access network in a LAN service company or other companies. Depending on the type of operation, the position information management server 212 may be installed in the same network as the position information notification server 222, or installed in another network separated by a Network address Translation (NAT) function or a firewall function.

Referring to FIG. 2, a Voice over Internet Protocol (VoIP) network 202 includes a call control server 221, a position information notification server 222, a subscriber information database 223, and a connection destination information database 224.

The call control server 221 shown in FIG. 2 basically has the same configuration as the call control server 121 shown in FIG. 1, and performs control for a call connection between the IP phone terminal 211 and the command system in the emergency call receiving organization 203. Further details of the call control server 221 are described later. Furthermore, the call control server 221 performs control for call-connections between the IP phone terminal 211 and other command systems in other emergency call receiving organizations, and control for call connections between other IP phone terminals and the command system in the emergency call receiving organization 203 in a similar manner.

The subscriber information database 223 shown in FIG. 2 basically has the same configuration as the subscriber information database 123 shown in FIG. 1. In the subscriber information database 223, the first terminal information of the IP phone terminal 211 such as an IP address or SIP-URI of the IP phone terminal 211 is managed and registered in the database. Likewise, in the subscriber information database 223, the terminal information of one or more IP phone terminals other than the IP phone terminal 211 is managed and registered in the database.

The connection destination information database 224 shown in FIG. 2 basically has the same configuration as the connection destination information database 124 shown in FIG. 1. In the connection destination information database 224, the second position information and the first device information such as an IP address or SIP-URI of the command system in the emergency call receiving organization 203, which will be described later, are managed and registered as a database. The second position information is, for example, position information which specifies an area over which the command system in the emergency call receiving organization 203 has jurisdiction. Further, the second position information may be, for example, position information of the command system in the emergency call receiving organization. In the connection destination information database 224, likewise, information of command systems other than the command system in the emergency call receiving organization 203 are managed and registered as a database. In the connection destination information database 224, likewise, position information of other command systems and the device information of other command systems such as an IP address or SIP-URI may be managed and registered as a database.

The connection destination information database 224 receives the first position information transmitted from the call control server 221, retrieves a second position in an area over which the command system in the emergency call receiving organization 203 has jurisdiction, and transmits the first device information corresponding to the second position. Alternatively, the connection destination information database 224 may receive the first position information transmitted from the call control server 221, retrieve a second position which is the nearest in terms of distance and shortest in terms of arrival time to the first position information, and transmit the first device information corresponding to this second position. Further, the connection destination information database 224 likewise receives other position information transmitted from the call control server 221, retrieves a position in an area for other position information, over which another command system in the emergency call receiving organization has jurisdiction, and transmits the device information corresponding to this position.

Referring to FIG. 2, the position information notification server 222 includes a second management section 225 which manages the first terminal information such as an IP address or SIP-URI of the IP phone terminal 211, and the first address of the position information server 212 such as an IP address of the position information server 212. The position information notification server 222 also includes a second processing section 226 which receives the first terminal information such as an IP address or SIP-URI of the IP phone terminal 211, transmits the first terminal information to the position information management server 212 on the basis of the first address information such as an IP address of the position information management server 212, receives the first position information from the position information management server 212, and transmits the first position information to a position information receiver 232 of the command system in the emergency call receiving organization. The second management section 225 likewise manages other terminal information and address information of the position information management server. The second processing section 226 receives other terminal information from the command system in the emergency call receiving organization 203, and processes it according to the other terminal information. The second processing section 226 likewise receives terminal information from other command systems, and processes it on the basis of this terminal information. In the second management section 225, the first terminal information, other terminal information, the first address information, and the like are registered, for example, via the position information management server 212.

The position information notification server 222 has a function of acquiring the first position information of the IP phone terminal 211 from the position information management server 212 and sending a reply, when the position information of the IP phone terminal 211 corresponding to the first terminal information is requested from the call control server 221. The second processing section 226 receives the first terminal information such as an IP address or SIP-URI of the IP phone terminal 211 from the call control server 221 transmits the first terminal information to the position information management server 212 on the basis of the first address information such as an IP address of the position management server 212, receives the first position information from the position information management server 212, and transmits the first position information to the call control server 221. The position information notification server 222 likewise has a function of acquiring position information of the other IP phone terminals from the position information management server 212 and sending a reply, when the position information of other IP phone terminals corresponding to other terminal information is requested from the call control server 221. The second processing section 226 receives the other terminal information from the call control server 221, transmits the other terminal information to the position information management server on the basis of other address information, receives position information from the position information management server on the basis of the other address information, and transmits this position information to the call control server 221.

Further, the call control server 221 receives a first signal containing the first terminal information such as an IP address or SIP-URI of the IP phone terminal 211, which was transmitted by the IP phone terminal 211. When the call control server 221 determines that the first signal connection is an emergency call by the first device information regarding the command system in the emergency call receiving organization 203 such as an IP address or SIP-URI regarding the command system in the emergency call receiving organization 203, the call control server 221 transmits the first terminal information of the position information management server 212 to the position information notification server 222. The call control server 221 likewise receives other signals containing other terminal information transmitted by other IP phone terminals. The call control server 221, when it is determined that another signal connection is an emergency call by device information regarding a command system, transmits other terminal information to the position information notification server 222.

The call control server 221 receives the first position information of the IP phone terminal 211 transmitted by the position information notification server 222, and transmits the first position information to the connection destination information database 224. The call control server 221 receives the first device information transmitted by the connection destination information database 224, and originates an outgoing call to the command system in the emergency call receiving organization 203 which has jurisdiction over (or is nearest to) the IP phone terminal 211 on the basis of the first device information. The call control server 221 likewise receives position information of other IP phone terminals transmitted by the position information notification server 222, and transmits the other position information to the connection destination information database 224. The call control server 221 likewise receives device information transmitted by the connection destination information database 224, and originates an outgoing call to another command system which has jurisdiction over (or is nearest to) another IP phone terminal on the basis of this device information.

The command system in the emergency call receiving organization 203 shown in FIG. 2 basically has the same configuration as the command system in the emergency call receiving organization 103 shown in FIG. 1. Referring to FIG. 2, the command system in the emergency call receiving organization 203 includes a command terminal 231 and a position information receiver 232. The command system in the emergency call receiving organization 203 may also include one or more command terminals other than the command terminal 231, but these command terminals are not shown in FIG. 2. The command system in the emergency call receiving organization 203 may also include one or more position information receivers other than the position information receiver 232, but these position information receivers are not shown in FIG. 2. Moreover, there may also be other command systems in emergency call receiving organizations in addition to the command system in the emergency call receiving organization 203, but these other command systems are not shown in FIG. 2.

The command terminal 231 shown in FIG. 2 basically has the same configuration as the command terminal 131 shown in FIG. 1, and receives an emergency call from the IP phone terminal 211 and sends a call back to the IP phone terminal 211. The position information receiver 232 shown in FIG. 2 basically has the same configuration as the position information receiver 132 shown in FIG. 1, and has functions of acquiring the first position information of the IP phone terminal 211 and displaying the acquired first position information of the IP phone terminal 211 on a map. Further, the command terminal 231 likewise receives emergency calls from other IP phone terminals, and sends call backs to the other IP phone terminals. The position information receiver 232 has functions of acquiring position information of other IP phone terminals and displaying the acquired position information of the other IP phone terminals on a map.

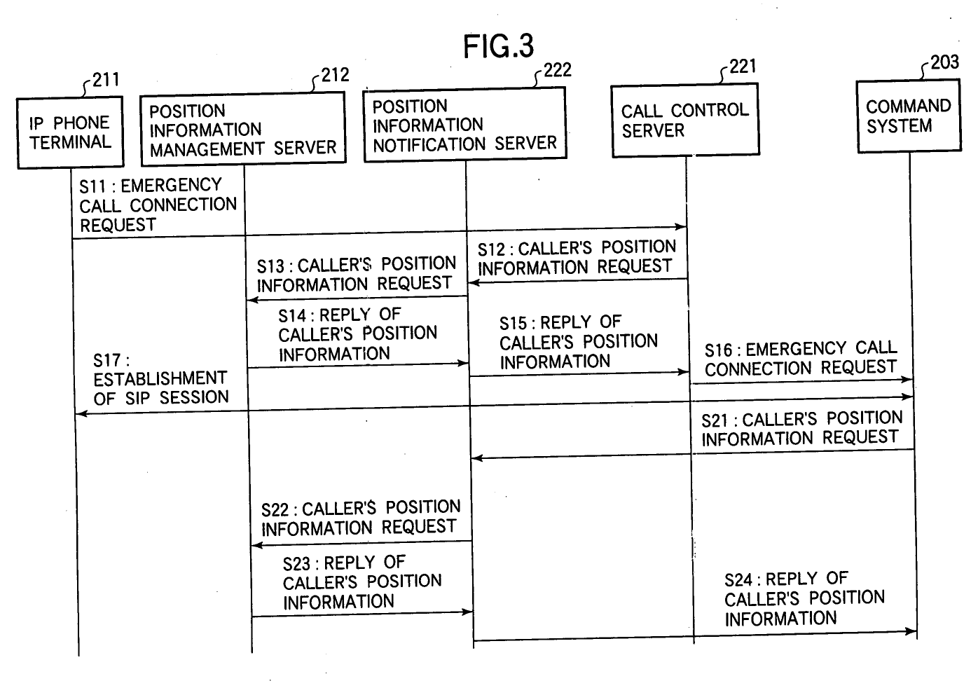

The operation of the first embodiment will now be described referring to FIG. 2 and FIG. 3.

Referring to FIG. 2, when the IP phone terminal 211 originates an emergency call (step S11 in FIG. 3), the call control server 221 requests the position information notification server 222 for position information of the IP phone terminal 211 as the caller's terminal by a message containing the first terminal information of the IP phone terminal 211 such as an IP address or SIP-URI of the IP phone terminal 211 (step S12 in FIG. 3).

The position information notification server 222, in which the first terminal information of the IP phone terminal 211 and the first address information of the position information management server 212 are registered beforehand so as to correspond to each other, specifies the first address information of the position information management server 212 from the first terminal information of the IP phone terminal 211, and requests the position information of the IP phone terminal 211 as the caller's terminal by a message containing the aforesaid first terminal information (step S13 in FIG. 3).

The position information management server 212 retrieves the first terminal information of the IP phone terminal 211 managed by the aforesaid method, and returns the first position information of the IP phone terminal 211 corresponding to the requested first terminal information (step S14 in FIG. 3).

The position information notification server 222 returns the acquired first position information to the call control server 221 (step S15 in FIG. 3), and the call control server 221 acquires the first device information of the command terminal 231 of the command system in the emergency call receiving organization 203 such as an IP address or SIP-URI of the command terminal 231 of the command system in the emergency call receiving organization 203, corresponding to the first position information from the connection destination information database 214.

The call control server 221 then issues an emergency call connection request to the command system in the emergency call receiving organization 203 (step S16 in FIG. 3), and establishes a call connection between the IP phone terminal 211 and the command system in the emergency call receiving organization 203 (step S17 in FIG. 3).

When the command system in the emergency call receiving organization 203 desires to check the position information of the IP phone terminal 211 as the caller's terminal, the position information receiver 232 issues a request for the first position information of the IP phone terminal 211 as the caller's terminal to the position information notification server 222 by a message containing the first terminal information of the IP phone terminal 211 (step S21 in FIG. 3). In this case, the position information notification server 222 issues an inquiry to the position information management server 212 as in the aforesaid steps S13 and S14 to request the first position information of the IP phone terminal 211 (step S22 in FIG. 3). The position information management server 212 then returns the first position information of the IP phone terminal 211 as the caller's terminal (step S23 in FIG. 3), and the position information notification server 222 returns this acquired first position information to the position information receiver 232 (step S24 in FIG. 3).

When an operator of the command system in the emergency call receiving organization 203 requests the first position information of the IP phone terminal 211 as the caller's terminal, regarding the way in which the first terminal information of the IP phone terminal 211 is input into the position information receiver 232, the operator can verify and input the information via a Graphical User Interface (GUI) of the command terminal 231, or it may be automatically acquired from the command terminal 231.

In the above, when the position information management server 212 is installed in a different network separated by a NAT function or the like, the IP phone terminal 211 uses a global IP address for transmitting to/receiving from the VoIP network 202. For this reason, in this case, a global IP address may be used as the first terminal information of the IP phone terminal 211.

According to the emergency call system or the emergency call method of the first embodiment, it is possible to provide a framework which permits acquisition of position information of an IP phone terminal, replies to inquiries for terminal position information from the command system in the emergency call receiving organization 203 having jurisdiction over (nearest to) the terminal, and provides a connection to the command system in the emergency call receiving organization 203 having jurisdiction over (nearest to) the terminal.

### <B> Second Embodiment

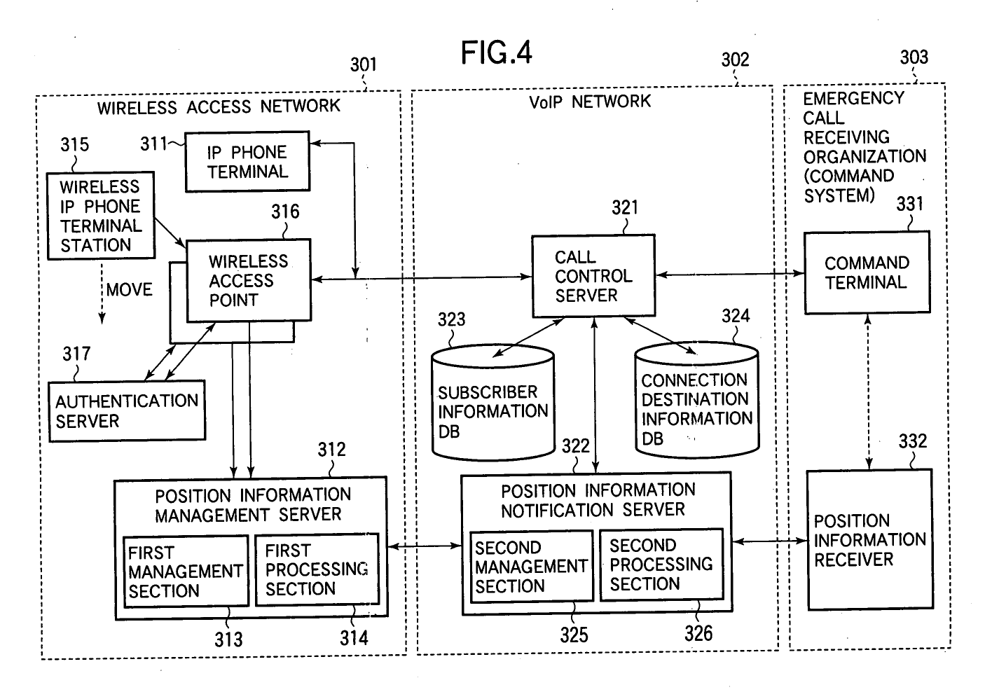

The second embodiment of the present invention will be described below in detail referring to the drawings. FIG. 4 is a block diagram showing a configuration including an emergency call system according to the second embodiment of the present invention. The emergency call system according to the second embodiment includes a wireless IP phone terminal station 315 in addition to the configuration of the access network 201 shown in FIG. 2.

Referring to FIG. 4, a wireless access network 301 includes an IP phone terminal 311 and a position information management server 312. The wireless access network 301 further includes a wireless IP phone terminal station 315, a wireless access point 316, and an authentication server 317. The wireless access network 301 may include one or more IP phone terminals other than the IP phone terminal 311, but the IP phone terminals other than the IP phone terminal 311 are not shown in FIG. 4. Further, one ore more wireless IP phone terminal stations other than the wireless IP phone terminal station 315 can be connected to the wireless access network 301 via a wireless access point, but the wireless IP phone terminal stations other than the wireless IP phone terminal station 315 are not shown in FIG. 4. Furthermore, there may also be one or more other wireless access network in addition to the wireless access network 301, but the wireless access network other than the wireless access network 301 are not shown in FIG. 4.

The IP phone terminal 311 shown in FIG. 4 basically has the same configuration as the IP phone terminal 211 shown in FIG. 2. The position information management server 312 shown in FIG. 4 basically has the same configuration as the position information management server 212 shown in FIG. 2. The detailed configuration of the position information management server 312 will be described later.

Referring to FIG. 4, the wireless IP phone terminal station 315 is connected to (or able to communicate with) the wireless access point 316. The wireless IP phone terminal station 315 may be connected to (or able to communicate with) other wireless access points.

The wireless access point 316 has a function of notifying a connection message regarding connection of the wireless IP phone terminal station 315 to the position information management server 312. The timing at which the wireless access point 316 notifies a connection message regarding connection of the wireless IP phone terminal station 315, is when the wireless IP phone terminal station 315 connects to the wireless access point 316, and when the wireless IP phone terminal station 315 moves between one wireless access point 316 and another wireless access point and re-connects to another wireless access point 316. At this timing, the wireless access point 316 issues a registration request for the first position information about the wireless IP phone terminal station 315 to the position information management server 312. Also, the timing at which the wireless access point 316 notifies a connection message regarding connection of the wireless IP phone terminal station 315, is when the wireless access point 316 terminates connection to the wireless IP phone terminal station 315. At this timing, the wireless access point 316 issues an invalidation request for the first position information regarding the wireless IP phone terminal station 315 to the position information management server 312. The wireless access point 316 also has a function of notifying a connection messages regarding connection of other IP phone terminals which are likewise connected to the position information management server 312.

The position information management server 312 shown in FIG. 3 basically has the same configuration as the position information management server 212 shown in FIG. 2. The position information management server 312 also manages the first position information notified from the wireless access point 316 corresponding to the first terminal information of the wireless IP phone terminal station 315. Examples of the first terminal information of the wireless IP phone terminal station 315 are an IP address of the wireless IP phone terminal station 315 and SIP-URI of the user who owns the wireless. IP phone terminal station 315. Likewise, the position information management server 312 manages position information notified from other wireless access points correspondingly to terminal information of other wireless IP phone terminal stations.

Referring to FIG. 4, the position information management server 312 includes a first management section 313 and a first processing section 314. The first management section 313 shown in FIG. 4 basically has the same configuration as the first management section 213 shown in FIG. 2, and manages the first terminal information of the wireless IP phone terminal station 315 and the first position information of the wireless IP phone terminal station 315. The first management section 313 also manages identification data (ID) of the wireless access point 316 and position information of the wireless access point 316. The first management section 313 likewise manages terminal information of other wireless IP phone terminal stations and position information of other wireless IP phone terminal stations.

The first processing section 314 shown in FIG. 4 basically has the same configuration as the first processing section 214 shown in FIG. 2. The first processing section 314 receives the first terminal information transmitted from the position information notification server 322 described later, and transmits the first position information to the position information notification server 322. Here, the first position information is managed correspondingly to the position information of the wireless access point 316 to which the wireless IP phone terminal station 315 is connected. The first processing section 314 likewise receives other terminal information transmitted from the position information notification server 322 described later, and transmits other position information to the position information notification server 322.

The position information management server 312 is managed by an operations manager of a wireless LAN access network, such as a wireless LAN service company. Depending on the type of operation, the position information management server 312 may be installed in the same network as the position information notification server 322, or may be installed in a different network separated by a NAT function or a firewall function.

When the wireless IP phone terminal station 315 connects with the wireless access point 316, an authentication server 317 performs terminal authentication, and if the terminal is properly authenticated, permits the wireless IP phone terminal station 315 to connect to the wireless access point 316. The authentication server 317 receives a user ID and a password from the wireless IP phone terminal station 315 via the wireless access point 316, and compares them with a user ID and a password registered in the wireless IP phone terminal station 315 beforehand. The comparison result is sent to the wireless access point 316 as a reply. When another wireless IP phone terminal station is connected to the wireless access point 316, the authentication server 317 likewise performs terminal authentication, and if the terminal is properly authenticated, permits the other wireless IP phone terminal station to connect to the wireless access point 316. The authentication server 317 receives user ID and passwords from other wireless IP phone terminal stations via the wireless access point 316, and compares them with the user ID and passwords registered in the other wireless IP phone terminal stations beforehand. The authentication server 317 likewise performs the terminal authentication, the connection permission, the comparison and the reply as described above for other wireless access points.

Referring to FIG. 4, the VoIP network 302 includes a call control server 321, a position information notification server 322, a subscriber information database 323, and a connection destination information database 324.

The call control server 321 shown in FIG. 4 basically has the same configuration as the call control server 121 shown in FIG. 2, and controls a call connection between the wireless IP phone terminal station 315 and the command system in the emergency call receiving organization 303 described later. Further details are given hereinafter. The call control server 321 also controls a call connection between the wireless IP phone terminal station 315 and other command systems in other emergency call receiving organizations, and controls a call connection between other wireless IP phone terminal stations and the command system in the emergency call receiving organization 303.

The subscriber information database 323 shown in FIG. 4 basically has the same configuration as the subscriber information database 223 shown in FIG. 2. The subscriber information database 323 manages the first terminal information of the wireless IP phone terminal station 315 such as an IP address or SIP-URI of the wireless IP phone terminal station 315, which is registered in the database. The subscriber information database 323 also manages wireless IP phone terminal stations other than the wireless IP phone terminal station 315, which are registered in the database.

The connection destination information database 324 shown in FIG. 4 basically has the same configuration as the connection destination information database 224 shown in FIG. 2. The connection destination information database 324 manages the second terminal information of the command system in the emergency call receiving organization 303, and an IP address or SIP-URI regarding the command system in the emergency call receiving organization 303 described later which is the first device information registered in the database. Here, the second position information is position information which specifies an area over which the command system in the emergency call receiving organization has jurisdiction. Alternatively, the second position information may be, for example, position information of the command system in the emergency call receiving organization. The connection destination information database 324 also manages command systems other than the command system in the emergency call receiving organization 303, and information about the command systems other than the command system in the emergency call receiving organization 303 is registered in the database. The connection destination information database 324 likewise manages IP addresses, SIP-URI and the like of other command systems, which is device information of these other command systems registered in the database.

The connection destination information database 324 receives the first position information transmitted from the call control server 321, retrieves a second position in an area, over which the command system in the emergency call receiving organization 303 has jurisdiction, and transmits the first device information corresponding to this second position. Alternatively, the connection destination information database 324 may receive the first position information transmitted from the call control server 321, retrieve a second position which is nearest in terms of distance and shortest in terms of arrival time to the first position, and transmit the first position information corresponding to this second position. The connection destination information database 324 likewise receives other position information transmitted from the call control server 321, retrieves a position in an area for other position information, over which another command system in the emergency call receiving organization has jurisdiction, and transmits the device information corresponding to this position.

The position information notification server 322 shown in FIG. 4 basically has the same configuration as the position information notification server 322 shown in FIG. 2, and has a function, when the position information of the wireless IP phone terminal station 315 is requested from a position information receiver 332 or the call control server 321, of acquiring the first position information of the wireless IP phone terminal station 315 from the position information management server 312, and of sending a reply. The position information notification server 322, when the position information of another wireless IP phone terminal station is requested from the position information receiver 332 or the call control server 321, likewise has a function of acquiring position information of the other wireless IP phone terminal station from the position information management server 312, and sending a reply. The position information notification server 322 has a further function, when the position information of a wireless IP phone terminal station is requested from other position information receivers, of acquiring position information of this wireless IP phone terminal station from the position information management server 312, and sending a reply.

Referring to FIG. 4, the position information notification server 322 includes a second management section 325 and a second processing section 326. The second management section 325 shown in FIG. 4 basically has the same configuration as the second management section 225 shown in FIG. 2, and also manages the first terminal information of the wireless IP phone terminal station 315 and the first address information of the position information management server 212. The second management section 325 likewise manages terminal information of other wireless IP phone terminal stations, and the address information of the position information management server. In addition, in the second management section 325, the first terminal information, other terminal information and the first address information are registered, for example, via the position information management server 312.

The second processing section 326 shown in FIG. 4 basically has the same configuration as the second processing section 226 shown in FIG. 2. The second processing section 326 receives the first terminal information such as an IP address or SIP-URI of the wireless IP phone terminal station 315, from the command system in the emergency call receiving organization 303, transmits the first terminal information to the position information management server 312 on the basis of the first address information, receives the first position information from the position information management server 312, and transmits the first position information to the command system in the emergency call receiving organization 303. The second processing section 326 likewise receives other terminal information from the command system in the emergency call receiving organization 303, transmits the other terminal information of other wireless IP phone terminal stations to the position information management server 312 on the basis of this address information, receives position information corresponding to the other terminal information from the position information management server 312, and transmits this position information to the command system in the emergency call receiving organization 303. The second processing section 326 also receives the first terminal information from the call control server 321, transmits the first terminal information to the position information management server 312 on the basis of the first address information, receives the first position information from the position information management server 312, and transmits the first position information to the call control server 321. The second processing section 326 likewise receives other terminal information from the call control server 321, transmits the other information to the position information management server 312 on the basis of this address information, receives position information corresponding to the other terminal information from the position information management server 312, and transmits this position information to the call control server 321.

The call control server 321 shown in FIG. 4 basically has the same configuration as the call control server 221 shown in FIG. 2. The call control server 321 receives a first signal containing the first terminal information such as an IP address or SIP-URI of the wireless IP phone terminal station 315, transmitted by the wireless IP phone terminal station 315. When the call control server 321 determines that the first signal is an emergency call by the fact that the information in the first signal is the first device information of the command system in the emergency call receiving organization 303, it transmits the first terminal information of the wireless IP phone terminal station 315 in the position information management server 312 to the position information notification server 322.

The call control server 321 likewise receives other signals which contain other terminal information transmitted by other wireless IP phone terminal stations. When the call control server 321 determines that another signal is an emergency call by the fact that the information in the other signal is device information of a command system, the call control server 321 transmits the other terminal information to the position information notification server 322.

The call control server 321 receives the first position information of the wireless IP phone terminal station 315 transmitted by the position information notification server 322, and transmits the first position information to the connection destination information database 324. The call control server 321 receives the first device information such as an IP address or SIP-URI regarding the command system in the emergency call receiving organization 303, transmitted by the connection destination information database 324, and originates an outgoing call to the command system in the emergency call receiving organization 303 which has jurisdiction over (nearest position to) the wireless IP phone terminal station 315 on the basis of the first device information.

The call control server 321 likewise receives position information of another wireless IP phone terminal station transmitted by the position information notification server 322, and transmits the other position information to the connection destination information database 324. The call control server 321 receives device information transmitted by the connection destination information database 324, and originates an outgoing call to the command system which has jurisdiction over (nearest position to) the other wireless IP phone terminal station on the basis of this first device information.

Referring to FIG. 4, the command system in the emergency call receiving organization 303 includes a command terminal 331 and a position information receiver 332. In addition to the command terminal 331, the command system in the emergency call receiving organization 303 may include plural command terminals, but these are not shown in FIG. 4. In addition to the position information receiver 332, the command system in the emergency call receiving organization 303 may include plural position information receivers, but these are not shown in FIG. 4. In addition to the command system in the emergency call receiving organization 303, there may also be other command systems in other emergency call receiving organizations, but these are not shown in FIG. 4.

The command terminal 331 basically has the same configuration as the command terminal 231 shown in FIG. 2, receives an emergency call from the wireless IP phone terminal station 315, and returns a signal to the wireless IP phone terminal station 315. The position information receiver 332 shown in FIG. 4 basically has the same configuration as the position information receiver 232 shown in FIG. 2, and has functions of acquiring position information of the wireless IP phone terminal station 315 and displaying the acquired position information of the wireless IP phone terminal station 315 on a map.

The command terminal 331 likewise receives an emergency call from other wireless IP phone terminal stations, and returns signals to the other wireless IP phone terminal stations. The position information receiver 332 has functions of acquiring position information of the other wireless IP phone terminal stations and displaying the acquired position information of the other IP phone terminals on a map.

The operation of the second embodiment will now be described referring to FIG. 2 and FIG. 3. Here, connection to the IP phone terminal 311 is the same as the operation of the first embodiment, so only connection to the wireless IP phone terminal station 315 will be described. The basic operation when a connection is made to the wireless IP phone terminal station 315 is the same as that when a connection is made to the IP phone terminal 211 shown in FIG. 2.

When a connection is made to the wireless IP phone terminal station 315, the wireless access point 316 receives a user ID and a password from the wireless IP phone terminal station 315 according to the authentication procedure defined by IEEE802.1X, and performs authentication of the user of the wireless IP phone terminal station 315 in collaboration with the authentication server 317. When user authentication is complete, the ID of the wireless access point 316 and the user ID of the wireless IP phone terminal station 315 are transmitted to the position information management server 312 as terminal connection messages.

In the position information management server 312, the user ID and the first terminal information of the wireless IP phone terminal station 315 such as an IP address or SIP-UPI of the wireless IP phone terminal station 315 are registered. Position information of the wireless access point 316 registered beforehand from the ID of the wireless access point 316, is registered as the first position information corresponding to the transmitted user ID such as an SIP-URI of wireless IP phone terminal station 315 from the terminal connection message transmitted when user authentication is complete.

The position information of the wireless access point is registered in the position information management server 312 when the wireless access point 316 is installed or when it is transferred.

Regarding the position information of the wireless access point, a position information measurement function such as GPS may alternatively be installed in the wireless access point 316 itself, and the position information measured by this position information measurement function may be registered in the position information management server 312 when the wireless access point is installed or transferred. The position registration may be implemented by including position information of the wireless access point 316 in the connection message for the wireless IP phone terminal station 315, or by having the position information management server 312 inquiry the wireless access point 316 for position information measurement data as required.

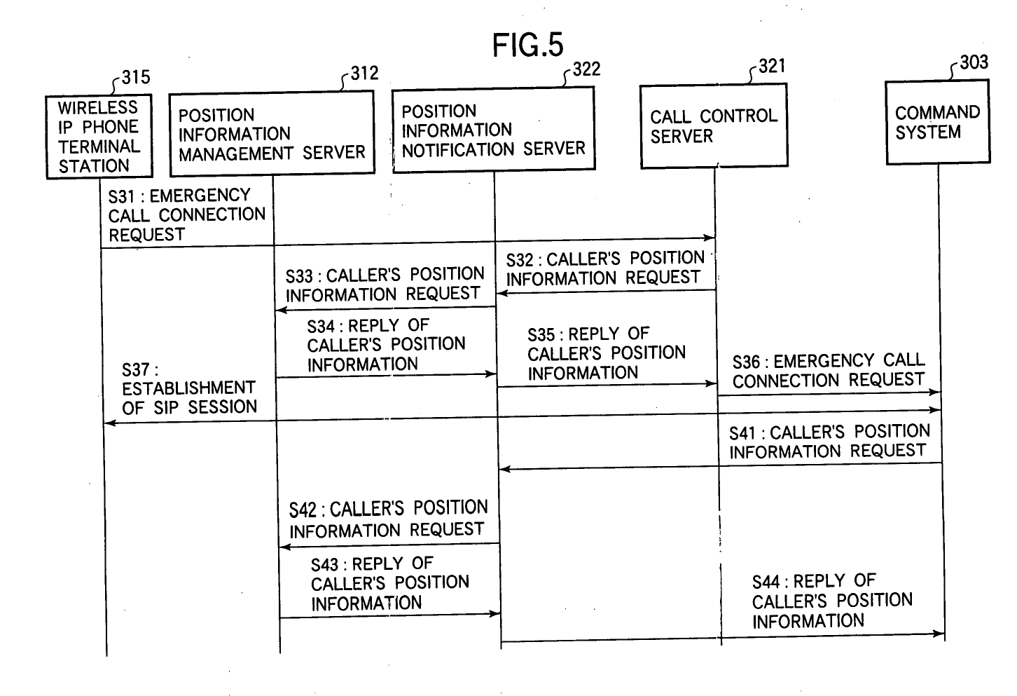

Referring to FIG. 4, when the wireless IP phone terminal station 315 originates an emergency call (step S31 in FIG. 5), the call control server 321 requests the position information notification server 322 for position information of the wireless IP phone terminal station 315 as the caller's terminal by a message containing the first terminal information such as an IP address or SIP-UPI of the wireless IP phone terminal station 315 (step S32 in FIG. 5).

The position information notification server 322, in which the first terminal information of the wireless IP phone terminal station 315 and the first address information of the position information management server 312 are registered beforehand so as to correspond to each other, specifies the first address information of the position information management server 312 from the first terminal information of the wireless IP phone terminal station 315, and requests the position information of the wireless IP phone terminal station 315 as the caller's terminal by a message containing the aforesaid first terminal information (step S33 in FIG. 5).

The position information management server 312 retrieves the first terminal information of the wireless IP phone terminal station 315 managed by the aforesaid method, and returns the requested first position information of the wireless IP phone terminal station 315 corresponding to the first terminal information (step S34 in FIG. 5).

The position information notification server 322 returns the acquired first position information to the call control server 321 (step S35 in FIG. 5), and the call control server 321 acquires the first device information of the command system in the emergency call receiving organization 303 such as an IP address or SIP-URI of the command terminal 331 of the command system in the emergency call receiving organization 303, corresponding to the first position information from the connection destination information database 314.

The call control server 321 then makes an emergency call connection request to the command system in the emergency call receiving organization 303 (step S36 in FIG. 5), and establishes a call connection between the wireless IP phone terminal station 315 and the command system in the emergency call receiving organization 303 (step S37 in FIG. 5).

When the command system in the emergency call receiving organization 203 desires to check the position information of the wireless IP phone terminal station 315 as the caller's terminal, by the command system in the emergency call receiving organization 303, the first position information of the wireless IP phone terminal station 315 is requested by the position information notification server 322 from the position-information receiver 332 by a message containing the first terminal information of the wireless IP phone terminal station 315 step S41 in FIG. 5). In this case, the position information notification server 322 issues an inquiry to the position information management server 312 as in steps S33 and S34 for the first position information of the wireless IP phone terminal station 315 (step S42 in FIG. 5), the position information management server 312 returns the first position information of the wireless IP phone terminal station 315 (step S43 in FIG. 5), and the position information notification server 322 returns this acquired first position information to the position information receiver 332 (step S44 in FIG. 5).

When requesting the first position information of the wireless IP phone terminal station 315 as the caller's terminal, from the command system in the emergency call receiving organization 303, the first terminal information of the wireless IP phone terminal station 315 may be input to the position information receiver 332 by an operator who checks the information via a GUI of the command terminal 431, or by automatic acquisition from the command terminal 331.

In the above, when the position information management server 312 is installed in a different network separated by a NAT function or the like, the wireless IP phone terminal station 315 uses a global IP address when transmitting to/receiving from the VoIP network 302. Therefore, in this case, a global IP address may be used as the first terminal information of the wireless IP phone terminal station 315.

According to the emergency call system or the emergency call method of the second embodiment, it is possible to obtain an advantage, in addition to the advantage of the first embodiment, that when the terminal is a wireless terminal station, even if the terminal moves to a different service area, the position information management device is specified from the address information of the terminal when the phone call is made, so the present position information of the terminal can be acquired.

### <C> Third Embodiment

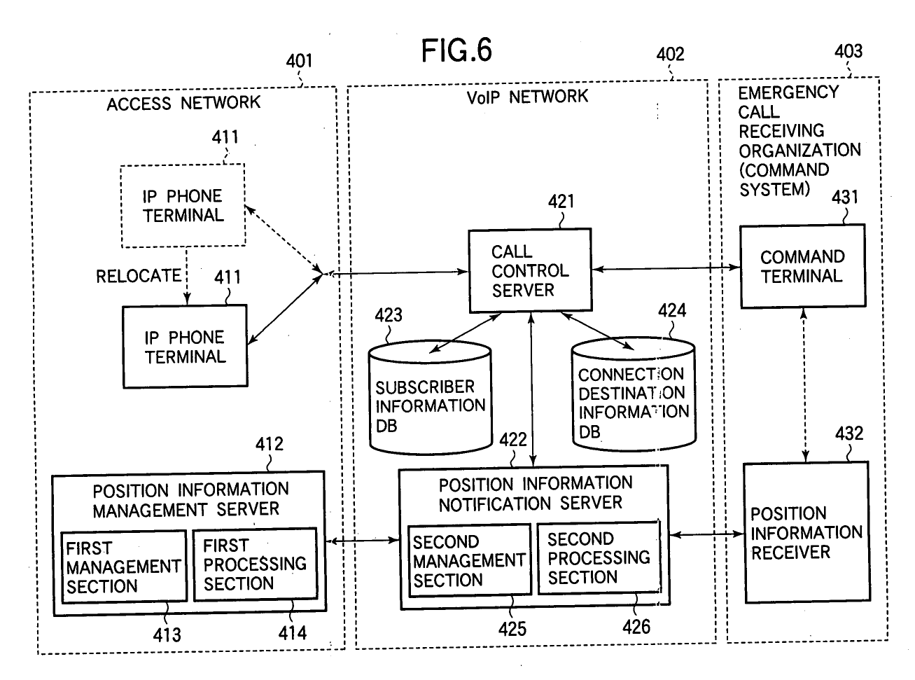

The third embodiment of the present invention will be described below in detail referring to the drawings. FIG. 6 is a block diagram showing a configuration including an emergency call system according to the third embodiment of the present invention. FIG. 6 shows a modified case where, in the configuration of the access network 201 shown in FIG. 2, the information of the IP phone terminal 211 is either the first terminal information or a network address managed by the position information management server 212. The emergency call system of the third embodiment of the present invention mainly differs from that of the first embodiment, with regard to the configuration of the position information notification server 222 shown in FIG. 2 and the configuration of the call control server 221 shown in FIG. 2 in the aforesaid first embodiment.

Referring to FIG. 6, the access network 401 includes an IP phone terminal 411 and a position information management server 412. The access network 401 can include one or more IP phone terminals other than the IP phone terminal 411, but the IP phone terminals other than the IP phone terminal 411 are not shown in FIG. 6. Further, there may also be one or more other access networks other than the access network 401, but the access networks other than the access network 401 are not shown in FIG. 6.

The IP phone terminal 411 shown in FIG. 6 basically has the same configuration as the IP phone terminal 211 shown in FIG. 2.

The position information management server 412 shown in FIG. 6 basically has the same configuration as the position information management server 212 shown in FIG. 2. The position information management server 412 manages the first position information of the IP phone terminal 411 correspondingly to the first terminal information of the IP phone terminal 411. An example of the first terminal information of the IP phone terminal 411 is an IP address of the IP phone terminal 411, or an SIP-URI of a user who owns the IP phone terminal 411. SIP is a protocol specified by, for example, RFC3261, and SIP-URI notation may, for example, consist of a domain name part and a local part. The position information management server 412 also manages IP phone terminals other than the IP phone terminal 411, and manages the position information of each other IP phone terminal correspondingly to the terminal information of each other IP phone terminal.

Referring to FIG. 6, the position information management server 412 includes a first management section 413 which manages the first terminal information of the IP phone terminal 411 and the first position information of the IP phone terminal 411, and a first processing section 414 which receives the first terminal information transmitted from a position information notification server 422, which will be described later in this specification, and transmits the first position information to the position information notification server 422. The first position information is registered on the basis of the position of the installed IP phone terminal 411 and the position of the transferred (or relocated) IP phone terminal 411, and is managed correspondingly to the first terminal information. The first management section 413 manages one or more IP phone terminals other than the IP phone terminal 411 in a similar manner. The first processing section 414 performs processing for one or more IP phone terminals other than the IP phone terminal 411 in a similar manner.

The position information management server 412 is managed by a LAN access network in a LAN service company or other companies. Depending on the type of operation, the position information management server 412 may be installed in the same network as the position information notification server 422, or installed in another network separated by a NAT function or a firewall function.

Referring to FIG. 6, a VoIP network 402 includes a call control server 421, a position information notification server 422, a subscriber information database 423, and a connection destination information database 424.

The call control server 421 shown in FIG. 6 basically has the same configuration as the call control server 221 shown in FIG. 2, and performs control for a call connection between the IP phone terminal 411 and the command system in the emergency call receiving organization 403. Further details of the call control server 421 are described later. Furthermore, the call control server 421 performs control for a call connection between the IP phone terminal 411 and other command systems in other emergency call receiving organizations, and control for call connections between other IP phone terminals and the command system in the emergency call receiving organization 403.

The subscriber information database 423 shown in FIG. 6 basically has the same configuration as the subscriber information database 223 shown in FIG. 2. In the subscriber information database 423, the first terminal information of the IP phone terminal 411 such as an IP address or SIP-URI of the IP phone terminal 411 is managed and registered in the database. Likewise, in the subscriber information database 423, terminal information of one or more IP phone terminals other than the IP phone terminal 411 is managed and registered in the database.

The connection destination information database 424 shown in FIG. 6 basically has the same configuration as the connection destination information database 224 shown in FIG. 2. In the connection destination information database 424, the second position information and the first device information such as an IP address or SIP-URI of the command system in the emergency call receiving organization 403, which will be described later, are managed and registered as a database. The second position information is, for example, position information which specifies an area over which the command system in the emergency call receiving organization has jurisdiction. Alternatively, the second position information may be, for example, position information of the command system in the emergency call receiving organization. In the connection destination information database 424, likewise, information of command systems other than the command system in the emergency call receiving organization 203 are managed and registered as a database. The connection destination information database 224 also manages position information of the other command systems, and the IP address or SIP-URI which is device information regarding the other command systems registered in the database.

The connection destination information database 424 receives the first position information transmitted from the call control server 421, retrieves a second position in an area over which the command system in the emergency call receiving organization 403 has jurisdiction, and transmits the first device information corresponding to the second position. Alternatively, the connection destination information database 424 may receive the first position information transmitted from the call control server 421, retrieve a second position which is the nearest in terms of distance and shortest in terms of arrival time to the first position information, and transmit the first device information corresponding to this second position. Further, the connection destination information database 424 likewise receives other position information transmitted from the call control server 421, retrieves a position in an area for other position information, over which another command system in the emergency call receiving organization has jurisdiction, and transmits the device information corresponding to this position.

Referring to FIG. 6, the position information notification server 422 includes a second management section 425 which manages the first terminal information such as an IP address or SIP-UPI of the IP phone terminal 411 or a network address managed by the position information management server 412, and the first address information such as an IP address of the position information management server 412. The position information notification server 422 further includes a second processing section 426 which receives the first terminal information such as an IP address or SIP-URI of the IP phone terminal 411, transmits the first terminal information to the position information management server 412 on the basis of the first address information such as an IP address of the position information management server 412, receives the first position information from the position information management server 412, and transmits the first position information to the position information receiver 432 of the command system in the emergency call receiving organization 403. The second management section 425 likewise manages other terminal information and address information of the position information management server. The second processing section 426 receives other terminal information from the command system in the emergency call receiving organization 403, and performs processing according to other terminal information. The second processing section 426 likewise receives terminal information from other command systems, and performs processing on the basis of this terminal information. In the second management section 425, the first terminal information, other terminal information, the first address information, and the like are registered, for example, via the position information management server 412.

The second processing section 426, when it receives for example an IP address or SIP-URI of the IP phone terminal 411 kept in the command system in the emergency call receiving organization 403, transmits the second terminal information to the call control server 421, and the terminal information managed by the call control server 421 may be used as the first terminal information at that time. The call control server 421 manages terminal information of IP phone terminals for which a call connection is controlled, retrieves the first terminal information such as an IP address or SIP-URI of the IP phone terminal 411, managed when the second terminal information is received from the position information notification server 422, and transmits the first terminal information to the position information notification server 422. The second processing section 426 receives the first terminal information from the call control server 421, transmits the first terminal information to the position information management server 412 on the basis of the first address information, receives the first position information from the position information management server 412, and transmits the first position information to the command system in the emergency call receiving organization 403 (position information receiver 432).

The position information notification server 422 has a function, when the position information of the IP phone terminal 411 corresponding to the first terminal information is requested from the call control server 421, of acquiring the first position information of the IP phone terminal 411 from the position information management server 412, and sending a reply. The second processing section 426 receives the first terminal information such as an IP address or SIP-URI of the IP phone terminal 411, from the call control server 421, transmits the first terminal information to the position information management server 412 on the basis of the first address information such as an IP address of position management server 412), receives the first position information from the position information management server 412, and transmits the first position information to the call control server 421. The position information notification server 422 likewise has a function, when the position information of another IP phone terminals corresponding to other terminal information is requested from the call control server 421, of acquiring position information of the other IP phone terminal from the position information management server 412, and sending a reply. The second processing section 426 receives the other terminal information from the call control server 421, transmits the other terminal information to the position information management server on the basis of the other address information, receives position information from the position information management server on the basis of the other address information, and transmits this position information to the call control server 421.

Even when the second management section 425 manages a network address managed by the position information management server 412, the first address information may be found, for example, as follows. For example, when the IP phone terminal 411 is in the access network 401, the first terminal information of the IP phone terminal 411 is managed by the position information management server 412 which is in the access network 401. At this time, since the IP phone terminal 411 and position information management server 412 are in the same access network 401, the network address (for example, “aaa.bbb.ccc”) of the IP address (for example, “aaa.bbb.ccc.xxx”) of the IP phone terminal 411 and the network address (for example, “aaa.bbb.ccc”) of the IP address (for example, “aaa.bbb.ccc.zzz”) of the position information management server 412 are the same. Therefore, if the IP address of the IP phone terminal 411 is known, the network address of the position information management server 412 which manages the IP phone terminal 411 is known, and the IP address of the position information management server 412 is known from the network address of the position information management server 412.

Further, the call control server 421 receives a first signal containing the first terminal information such as an IP address or SIP-URI of the IP phone terminal 411, which was transmitted by the IP phone terminal 411. When the call control server 421 determines that the first signal connection is an emergency call by the first device information regarding the command system in the emergency call receiving organization 403 such as an IP address or SIP-URI of the command system in the emergency call receiving organization 403, the call control server 421 transmits the first terminal information of the position information management server 412 to the position information notification server 422. The call control server 421 likewise receives other signals containing other terminal information transmitted by other IP phone terminals. When the call control server 421 determines that another signal connection is an emergency call by device information regarding a command system, the call control server 421 transmits other terminal information to the position information notification server 422.

The call control server 421 receives the first position information of the IP phone terminal 411 transmitted by the position information notification server 422, and transmits the first position information to the connection destination information database 424. The call control server 421 receives the first device information transmitted by the connection destination information database 424, and originates an outgoing call to the command system in the emergency call receiving organization 403 which has jurisdiction over (or is nearest to) the IP phone terminal 411 on the basis of the first device information. The call control server 421 likewise receives position information of other IP phone terminals transmitted by the position information notification server 422, and transmits the other position information to the connection destination information database 424. The call control server 421 likewise receives device information transmitted by the connection destination information database 424, and originates an outgoing call to another command system which has jurisdiction over (or is nearest to) another IP phone terminal on the basis of this device information.

The command system in the emergency call receiving organization 403 shown in FIG. 6 basically has the same configuration as the command system in the emergency call receiving organization 203 shown in FIG. 2. Referring to FIG. 6, the command system in the emergency call receiving organization 403 includes a command terminal 431 and a position information receiver 432. The command system in the emergency call receiving organization 403 may also include one or more command terminals other than the command terminal 431, but these command terminals are not shown in FIG. 6. The command system in the emergency call receiving organization 403 may also include one or more position information receivers other than the position information receiver 432, but these position information receivers are not shown in FIG. 6. Moreover, there may also be command systems in emergency call receiving organizations in addition to the command system in the emergency call receiving organization 403, but these other command systems are not shown in FIG. 6.

The command terminal 431 shown in FIG. 6 basically has the same configuration as the command terminal 231 shown in FIG. 2, and receives an emergency call from the IP phone terminal 411 and sends a call back to the IP phone terminal 411. The position information receiver 432 shown in FIG. 6 basically has the same configuration as the position information receiver 232 shown in FIG. 2, and has functions of acquiring the first position information of the IP phone terminal 411 and displaying the acquired first position information of the IP phone terminal 411 on a map. Further, the command terminal 431 likewise receives emergency calls from other IP phone terminals, and sends call backs to the other IP phone terminals. The position information receiver 432 has functions of acquiring position information of other IP phone terminals and displaying the acquired position information of the other IP phone terminals on a map.

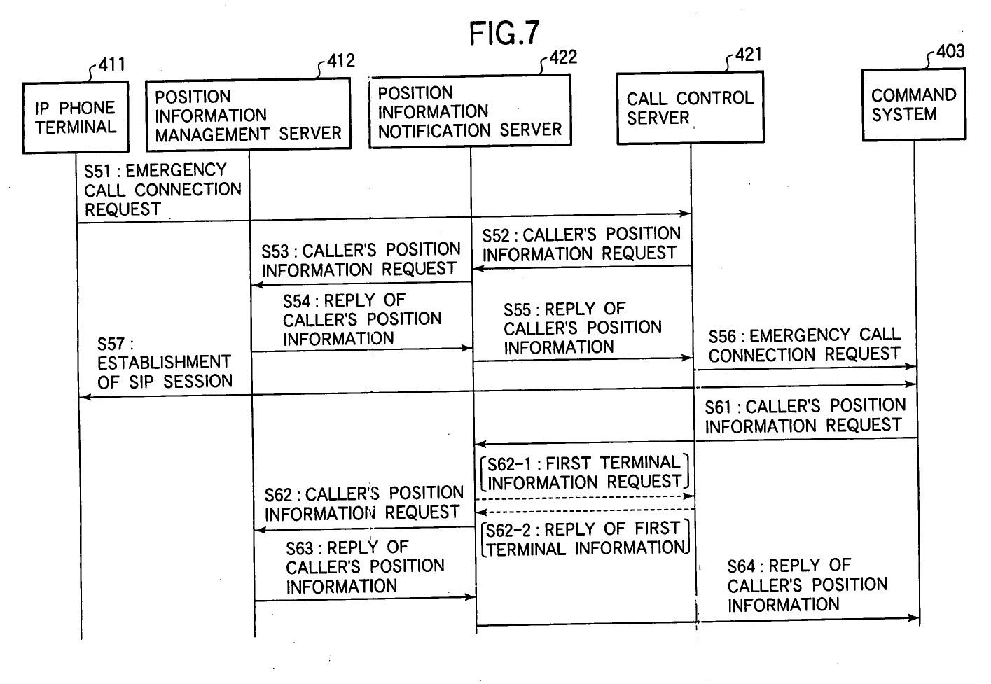

The operation of the third embodiment will now be described, referring to FIG. 6 and FIG. 7. The operation of this third embodiment mainly differs from the operation of the first embodiment in steps S53 and S62 in FIG. 7. Step S53 in FIG. 7 is a step corresponding to step S13 in FIG. 3 of the operation of the aforesaid first embodiment, and step S62 in FIG. 7 is a step corresponding to step S22 in FIG. 3 of the operation of the aforesaid first embodiment.

Referring to FIG. 6, when the IP phone terminal 411 originates an emergency call (step S51 in FIG. 7), the call control server 421 requests the position information notification server 422 for position information of the IP phone terminal 411 as the caller's terminal by a message containing the first terminal information of the IP phone terminal 411 such as an IP address or SIP-URI of the IP phone terminal 411 (step S52 in FIG. 7).

The position information notification server 422, in which the first terminal information of the IP phone terminal 411 or the network address managed by the position information management server 412, and the first address information of the position information management server 412 are registered beforehand so as to correspond to each other, specifies the first address information of the position information management server 412 from the first terminal information of the IP phone terminal 211, and requests the position information of the IP phone terminal 211 as the caller's terminal by a message containing the aforesaid first terminal information (step S53 in FIG. 7).

The position information management server 412 retrieves the first terminal information of the IP phone terminal 411 managed by the aforesaid method, and returns the first position information of the IP phone terminal 411 corresponding to the requested first terminal information (step S54 in FIG. 7).

The position information notification server 422 returns the acquired the first position information to the call control server 421 (step S55 in FIG. 7), and the call control server 421 acquires the first device information of the command terminal 431 of the command system in the emergency call receiving organization 403 such as an IP address or SIP-URI of the command terminal 431 of the command system in the emergency call receiving organization 403, corresponding to the first position information from the connection destination information database 414.

The call control server 421 then issues an emergency call connection request to the command system in the emergency call receiving organization 403 (step S56 in FIG. 7), and establishes a call connection between the IP phone terminal 411 and the command system in the emergency call receiving organization 403 (step 537 in FIG. 7).

When the command system in the emergency call receiving organization 403 desires to check the position information of the IP phone terminal 411 as the caller's terminal, the position information receiver 432 issues a request for the first position information of the IP phone terminal 411 as the caller's terminal to the position information notification server 422 by a message containing the first terminal information of the IP phone terminal 411 (step S61 in FIG. 7). In this case, the position information notification server 422 issues an inquiry to the position information management server 412 as in steps S53 and S54 to request the first position information of the IP phone terminal 411 as the caller's terminal (step S62 in FIG. 7). The position information management server 412 then returns the first position information of the IP phone terminal 411 as the caller's terminal (step S63 in FIG. 7), and the position information notification server 422 returns this acquired first position information to the position information receiver 432 (step S64 in FIG. 7).

When an operator of the command system in the emergency call receiving organization 403 requests the first position information of the IP phone terminal 411 as the caller's terminal, regarding the way in which the first terminal information of the IP phone terminal 411 is input into the position information receiver 432, the operator can verify and input the information via a GUI of the command terminal 431, or it may be automatically acquired from the command terminal 431.

Next, in the operation of the third embodiment, the command system in the emergency call receiving organization 403 knows an SIP-URI (the second terminal information) of the IP phone terminal 411 as the first terminal information of the IP phone terminal 411. An operation example, Case C1, will now be described where the position information notification server 422 manages network addresses managed by the position information management server 412, and manages correspondence information of the position information management server 412 (steps S61 to S64 in FIG. 7). Another operation example, Case C2, will also be described where an IP address or SIP-URI (the second terminal information) of the IP telephone terminal 411 are known, the position information notification server 422 manages network addresses managed by the position information management server 412, and manages correspondence information of the position information management server 412 (steps S61 to S64 in FIG. 7). In Cases C1 and C2, as an example, the situation is shown where, in the second processing section 426, when the second terminal information held by the command system in the emergency call receiving organization 403 (an IP address or SIP-UPI of the IP phone terminal 411) is received, the second terminal information is transmitted to the call control server 421, and the terminal information managed by the call control server 421 at that time is used as the first terminal information.

(Case C1)

In step 61 in FIG. 7, when the command system in the emergency call receiving organization 403 desires to check the position information of the IP phone terminal 411 as the caller's terminal, the position information receiver 432 requests the position information notification server 422 for the first position information of the IP phone terminal 411 as the caller's terminal by using a message containing the SIP-URI which is the second terminal information of the IP phone terminal 411 as the caller's terminal.

The position information notification server 422 transmits the SIP-URI which is the second terminal information of the IP phone terminal 411, to the call control server 421 (step S62-1 in FIG. 7). The call control server 421, when the IP phone terminal 411 is calling/talking, manages an SIP-URI, an IP address and the like, which are the first terminal information of the IP phone terminal 411, or knows where to get an SIP-URI, an IP address and the like. Therefore, the call control server 421 retrieves an IP address which is the first terminal information of the present IP phone terminal 411, from the SIP-URI which is the received second terminal information of the IP phone terminal 411. The call control server 421 transmits the IP address which is the retrieved first terminal information to the position information notification server 422 (step S62-2 in FIG. 7).

The network address managed by the position information management server 412 and the IP address which is the first address information of the position information management server 412 are registered beforehand in the position information notification server 422 so as to correspond to each other. The position information notification server 422 retrieves a corresponding network address from the received IP address which is the first terminal information, and specifies the IP address of the position information management server 412 from the retrieved network address. The position information notification server 422 requests the specified position information management server 412 for the position information of the IP phone terminal 411 as the caller's terminal by a message containing the IP address which is the first terminal information (step S62 in FIG. 7).

Here, as an example, let the network address in the IP address which is the first terminal information and the network address managed by the position information management server 412 be “aaa.bbb.ccc”, the IP address which is the first terminal information of the IP phone terminal 411 be “aaa.bbb.ccc.xxx”, and the IP address of the position information management server 412 be “aaa.bbb.ccc.zzz”. Let the network address managed by other position information management server be “aaa.bbb.ddd”, and the IP address of other position information management server be “aaa.bbb.ccc.zzz”. When the IP phone terminal 411 is transferred (moved) to another access network, the IP phone terminal 411 is registered in another position information management server, so the IP address of the IP phone terminal 411 at this time will be “aaa.bbb.ddd.xxx”, and the network address in the IP address which is the first terminal information will be “aaa.bbb.ddd”.

In step S63 in FIG. 7, the position information management server 412 retrieves the IP address which is the first terminal information of the IP phone terminal 411 managed by the aforesaid method, and returns the first position information of the IP phone terminal 411 corresponding to the requested IP address to the position information notification server 422. At this time, if the IP phone terminal 411 is in the access network 401, the IP address which is the first terminal information of the IP phone terminal 411 is “aaa.bbb.ccc.xxx”. If the IP phone terminal 411 moves from the access network 401 to another access network and is in another access network, the IP address which is the first terminal information of the IP phone terminal 411 is “aaa.bbb.ddd.xxx”.

In step S64 in FIG. 7, the position information notification server 422 acquires the first position information of the IP phone terminal 411 as the caller's terminal, and returns this first position information to the position information receiver 432.

(Case C2)

In step 61 in FIG. 7, when the command system in the emergency call receiving organization 403 desires to check the position information of the IP phone terminal 411 as the caller's terminal, the position information receiver 432 requests the position information notification server 422 for the first position information of the IP phone terminal 411 as the caller's terminal by using a message containing the IP address and the SIP-URI which are the second terminal information of the IP phone terminal 411 as the caller's terminal.

The network address managed by the position information management server 412 and the IP addresses which is the first address information of the position information management server 412 are registered beforehand in the position information notification server 422 so as to correspond to each other. The position information notification server 422 retrieves a corresponding network address from the received IP address which is the second terminal information, and specifies the IP address of the position information management server 412 from the retrieved network address. The position information notification server 422 requests the specified position information management server 412 for the position information of the IP phone terminal 411 as the caller's terminal by a message containing the IP address which is the second terminal information (step S62 in FIG. 7).

Here, as an example, let the network address in the IP address which is the first terminal information and the network address managed by the position information management server 412 be “aaa.bbb.ccc”, the IP address which is the first terminal information of the IP phone terminal 411 be “aaa.bbb.ccc.xxx”, and the IP address of the position information management server 412 be “aaa.bbb.ccc.zzz”. Let the network address managed by other position information management server be “aaa.bbb.ddd”, and the IP address of other position information management server be “aaa.bbb.ccc.zzz”. When the IP phone terminal 411 is transferred (moved) to another access network, the IP phone terminal 411 is registered in another position information management server, so the IP address of the IP phone terminal 411 at this time will be “aaa.bbb.ddd.xxx”, and the network address in the IP address which is the first terminal information will be “aaa.bbb.ddd”.

In step S63 in FIG. 7, when the IP address which is the second terminal information is equal to the IP address which is the first terminal information, the position information management server 412 retrieves the IP address which is the first terminal information of the IP phone terminal 411 managed by the aforesaid method, and returns the first position information of the IP phone terminal 411 corresponding to the requested IP address which is the first terminal information to the position information notification server 422. At this time, if the IP address which is the second terminal information of the IP phone terminal is “aaa.bbb.ccc.xxx” and the IP phone terminal 411 is in the access network 401, the IP address which is the first terminal information of the IP phone terminal 411 is “aaa.bbb.ccc.xxx”.

In step S64 in FIG. 7, the position information notification server 422 acquires the first position information of the IP phone terminal 411 as the caller's terminal, and returns this first position information to the position information receiver 432.

However, although the IP address which is the second terminal information of the IP phone terminal 411 is “aaa.bbb.ccc.xxx”, if the IP phone terminal 411 is transferred (moved) from the access network 401 to another access network and is in another access network, the IP address which is the first terminal information of the IP phone terminal 411 is “aaa.bbb.ddd.xxx”. At this time, the first position information of the IP phone terminal 411 cannot be acquired from the position information management server 412, so this is performed using the SIP-URI which is the second terminal information of the IP phone terminal 411 by the similar procedure described in the aforesaid Case C1 and shown in steps S62 to S64 in FIG. 7.

The position information notification server 422 transmits the SIP-URI which is the second terminal information of the IP phone terminal 411, to the call control server 421 (step S62-1 in FIG. 7). The call control server 421, when the IP phone terminal 411 is calling/talking, manages the SIP-URI, the IP address and the like, which are the first terminal information of the IP phone terminal 411, or knows where to get the SIP-URI, the IP address and the like. Therefore, the call control server 421 retrieves the IP address which is the first terminal information of the present IP phone terminal 411, from the SIP-URI which is the received second terminal information of the IP phone terminal 411. The call control server 421 transmits the IP address which is the retrieved first terminal information to the position information notification server 422 (step S62-2 in FIG. 7).

The network address managed by the position information management server 412 and the IP addresses which is the first address information of the position information management server 412 are registered beforehand in the position information notification server 422 so as to correspond to each other. The position information notification server 422 retrieves a corresponding network address from the received IP address which is the first terminal information, and specifies the IP address of the position information management server 412 from the retrieved network address. The position information notification server 422 requests the specified position information management server 412 for the position information of the IP phone terminal 411 as the caller's terminal by a message containing the IP address which is the first terminal information.

In step S63 in FIG. 7, the position information management server 412 retrieves the IP address which is the first terminal information of the IP phone terminal 411 managed by the aforesaid method, and returns the first position information of the IP phone terminal 411 corresponding to the requested IP address which is the first terminal information to the position information notification server 422. Since the IP phone terminal 411 is transferred (moves) from the access network 401 to another access network and is in another access network at this time, the IP address which is the first terminal information of the IP phone terminal 411 is “aaa.bbb.ddd.xxx”.

In step S64 in FIG. 7, the position information notification server 422 acquires the first position information of the IP phone terminal 411 as the caller's terminal, and returns this first position information to the position information receiver 432.

Although the SIP-URI which is the second terminal information was not shown in steps S62, S62-2 and S64 in FIG. 7, the SIP-URI which is the second terminal information may be transmitted/received in each step.

In the above, when the position information management server 412 is installed in a different network separated by a NAT function or the like, the IP phone terminal 411 uses a global IP address when transmitting to/receiving from the VoIP network 402. Therefore, in this case, a global IP address may be used as the first terminal information of the IP phone terminal 411.

According to the emergency call system or emergency call method of the third embodiment, even when the first terminal information or the network address managed by the position information management server is used as IP phone terminal information, it is possible to provide a framework which can acquire position information about the IP phone terminal and reply to inquiries about terminal position from a command system in an emergency call receiving organization having jurisdiction, and can connect the terminal to the command system in the nearest emergency call receiving organization having jurisdiction over (nearest to) the terminal.

### <D> Fourth Embodiment

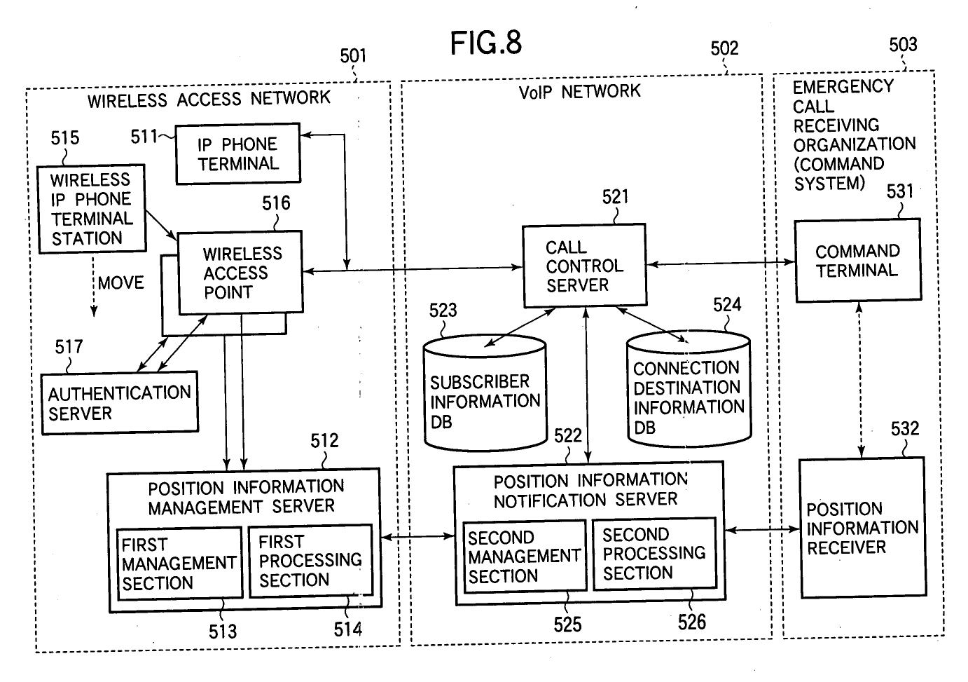

The fourth embodiment of the present invention will be described below in detail referring to the drawings. FIG. 8 is a block diagram showing a configuration including an emergency call system according to the fourth embodiment of the present invention. The emergency call system according to the second embodiment includes a wireless IP phone terminal station 515 in addition to the configuration of the access network 401 shown in FIG. 6.

Referring to FIG. 8, a wireless access network 501 includes an IP phone terminal 511 and a position information management server 512. The wireless access network 501 further includes a wireless IP phone terminal station 515, a wireless access point 516, and an authentication server 517.

The wireless access network 501 may include one or more IP phone terminals other than the IP phone terminal 511, but the IP phone terminals other than the IP phone terminal 511 are not shown in FIG. 8. Further, one ore more wireless IP phone terminal stations other than the wireless IP phone terminal station 515 can be connected to the wireless access network 501 via a wireless access point, but the wireless IP phone terminal stations other than the wireless IP phone terminal station 515 are not shown in FIG. 8. Furthermore, there may also be one or more other wireless access network in addition to the wireless access network 501, but the wireless access network other than the wireless access network 501 are not shown in FIG. 8.

The IP phone terminal 511 shown in FIG. 8 basically has the same configuration as the IP phone terminal 411 shown in FIG. 6. The position information management server 512 shown in FIG. 8 basically has the same configuration as the position information management server 412 shown in FIG. 6. The detailed configuration of the position information management server 512 is described later.

The wireless IP phone terminal station 515 is connected to (or able to communicate with) the wireless access point 516. The wireless IP phone terminal station 515 can be connected to (or able to communicate with) other wireless access points.

The wireless access point 516 has a function of notifying a connection message regarding connection of the wireless IP phone terminal station 515 to the position information management server 512. The timing at which the wireless access point 516 notifies a connection message regarding connection of the wireless IP phone terminal station 515, is when the wireless IP phone terminal station 515 connects to the wireless access point 516, and when the wireless IP phone terminal station 515 moves between one wireless access point 516 and another wireless access point and re-connects to another wireless access point 516. At this timing, the wireless access point 516 issues a registration request for the first position information about the wireless IP phone terminal station 515 to the position information management server 512. Also, the timing at which the wireless access point 516 notifies a connection message regarding connection of the wireless IP phone terminal station 515, is when the wireless access point 516 terminates connection to the wireless IP phone terminal station 515. At this timing, the wireless access point 316 issues an invalidation request for the first position information regarding the wireless IP phone terminal station 515 to the position information management server 512. The wireless access point 516 also has a function of notifying a connection message regarding connection of other IP phone terminals which are likewise connected, to the position information management server 512.

The position information management server 512 shown in FIG. 8 basically has the same configuration as the position information management server 412 shown in FIG. 6. The position information management server 512 also manages the first position information notified from the wireless access point 516 correspondingly with the first terminal information of the wireless IP phone terminal station 515. Examples of the first terminal information of the wireless IP phone terminal station 515 are an IP address of the wireless IP phone terminal station 515 and an SIP-URI of the user who owns the wireless IP phone terminal station 515. Likewise, the position information management server 512 manages position information notified from other wireless access points correspondingly to terminal information of other wireless IP phone terminal stations.

Referring to FIG. 8, the position information management server 512 includes a first management section 513 and a first processing section 514. The first management section 513 shown in FIG. 8 basically has the same configuration as the first management section 413 shown in FIG. 6, and manages the first terminal information of the wireless IP phone terminal station 515 and the first position information of the wireless IP phone terminal station 515. The first management section 513 also manages the ID of the wireless access point 516 and position information of the wireless access point 516. The first management section 513 likewise manages terminal information of other wireless IP phone terminal stations and position information of other wireless IP phone terminal stations.

The position information management server 512 is managed by an operations manager of a wireless LAN access network, such as a wireless LAN service company. Depending on the type of operation, the position information management server 512 may be installed in the same network as the position information notification server 522, or may be installed in a different network separated by a NAT function or a firewall function.

The first processing section 514 shown in FIG. 8 basically has the same configuration as the first processing section 414 shown in FIG. 6. The first processing section 514 receives the first terminal information transmitted by the position information notification server 522 described later, and transmits the first position information to the position information notification server 522. Here, the first position information is managed correspondingly with position information of the wireless access point 516 to which the wireless IP phone terminal station 515 is connected. The first processing section 514 likewise receives other terminal information transmitted from the position information notification server 522 described later, and transmits other position information to the position information notification server 522.

When the wireless IP phone terminal station 515 connects with the wireless access point 516, the authentication server 517 performs terminal authentication, and if the terminal is properly authenticated, permits the wireless IP phone terminal station 515 to connect to the wireless access point 516. The authentication server 517 receives a user ID and a password from the wireless IP phone terminal station 515 via the wireless access point 516, and compares them with a user ID and a password registered in the wireless IP phone terminal station 515 beforehand. The comparison result is sent to the wireless access point 516 as a reply. When another wireless IP phone terminal station is connected to the wireless access point 516, the authentication server 517 likewise performs terminal authentication, and if the terminal is properly authenticated, permits the other wireless IP phone terminal station to connect to the wireless access point 516. The authentication server 517 likewise receives user ID and passwords from other wireless IP phone terminal stations via the wireless access point 516, and compares them with the user ID and passwords registered in the other wireless IP phone terminal stations beforehand. The authentication server 517 likewise performs the terminal authentication, the connection permission, the comparison and the reply as described above for other wireless access points.

However, the authentication server 517 is not always used. The operation when the authentication server 517 is not used will be described later.

Referring to FIG. 8, the VoIP network 502 includes a call control server 521, a position information notification server 522, a subscriber information database 523, and a connection destination information database 524.

The call control server 521 shown in FIG. 8 basically has the same configuration as the call control server 421 shown in FIG. 6, and controls a call connection between the wireless IP phone terminal station 515 and the command system in the emergency call receiving organization 503 described later. Further details are given hereinafter. The call control server 521 also controls a call connection between the wireless IP phone terminal station 515 and other command systems in other emergency call receiving organizations, and controls a call connection between other wireless IP phone terminal stations and the command system in the emergency call receiving organization 503.

The subscriber information database 523 shown in FIG. 8 basically has the same configuration as the subscriber information database 523 shown in FIG. 6. The subscriber information database 523 manages the first terminal information of the wireless IP phone terminal station 515 such as an IP address or SIP-URI of the wireless IP phone terminal station 515, which is registered in the database. The subscriber information database 523 also manages wireless IP phone terminal stations other than the wireless IP phone terminal station 515, which are registered in the database.

The connection destination information database 524 shown in FIG. 8 basically has the same configuration as the connection destination information database 424 shown in FIG. 6. The connection destination information database 524 manages the second position information of the command system in the emergency call receiving organization 503, and the IP address or SIP-URI regarding the command system in the emergency call receiving organization 503 described later which is the first device information registered in the database. Here, the second position information is position information which specifies an area over which the command system in the emergency call receiving organization has jurisdiction. Alternatively, the second position information may be, for example, position information of the command system in the emergency call receiving organization. The connection destination information database 524 also manages command systems other than the command system in the emergency call receiving organization 503, and information about the command systems other than the command system in the emergency call receiving organization 303 is registered in the database. The connection destination information database 524 likewise manages position information of the other command systems, and device information such as an IP address or SIP-URI for the other command systems and information about the command systems other than the command system in the emergency call receiving organization 303 is registered in the database.

The connection destination information database 524 receives the first position information transmitted from the call control server 521, retrieves a second position in an area, over which the command system in the emergency call receiving organization 503 has jurisdiction, and transmits the first device information corresponding to this second position. Alternatively, the connection destination information database 524 may receive the first position information transmitted from the call control server 521, retrieve a second position which is nearest in terms of distance and shortest in terms of arrival time to the first position, and transmit the first device information corresponding to this second position. The connection destination information database 524 likewise receives other position information transmitted from the call control server 521, retrieves a position in an area for other position information, over which another command system in the emergency call receiving organization has jurisdiction, and transmits device information corresponding to this position.

The position information notification server 522 shown in FIG. 8 basically has the same configuration as the position information notification server 422 shown in FIG. 6, and has a function, when the position information of the wireless IP phone terminal station 515 is requested from a position information receiver 532 or call control server 521, of acquiring the first position information of the wireless IP phone terminal station 515 from the position information management server 512, and sending a reply. The position information notification server 522, when the position information of another wireless IP phone terminal station is requested from the position information receiver 532 or the call control server 521, likewise has a function of acquiring position information of the other wireless IP phone terminal station from the position information management server 512, and sending a reply. The position information notification server 522 has a further function, when the position information of a wireless IP phone terminal station is required from other position information receivers, of acquiring position information of this wireless IP phone terminal station from the position information management server 512, and sending a reply.

Referring to FIG. 8, the position information notification server 522 includes a second management section 525 and a second processing section 526.

The second management section 525 shown in FIG. 8 basically has the same configuration as the second management section 425 shown in FIG. 6, and also manages the first terminal information such as an IP address or SIP-UPI of the wireless IP phone terminal station 515, or the network addresses managed by the position information management server 512, and the first address information of the position information management server 512. The second processing section 426 shown in FIG. 8 basically has the same configuration as the second processing section 426 shown in FIG. 6. The second processing section 426 receives the first terminal information such as an IP address or SIP-URI of the wireless IP phone terminal station 515, from the command system in the emergency call receiving organization 403, transmits the first terminal information to the position information management server 512 on the basis of the first address information such as an IP address of the position management server 512, receives the first position information from the position information management server 512, and transmits the first position information to the command system in the emergency call receiving organization 503.

The second management section 525 likewise manages other terminal information in other wireless IP phone terminal stations or network addresses managed by the position information management server 512, and manages address information of the position information management server. In the second management section 525, the first terminal information, other terminal information, the first address information, and the like are registered, for example, via the position information management server 512. The second processing section 526 receives other terminal information in other wireless IP phone terminal stations from the command system in the emergency call receiving organization 503, and processes it on the basis of this other terminal information. The second processing section 526 likewise receives other terminal information from other command systems, and processes it on the basis of this terminal information.

The second processing section 526, when it receives second terminal information such as an IP address or SIP-URI of the IP phone terminal 515 kept in the command system in the emergency call receiving organization 503, transmits the second terminal information to the call control server 521, and the terminal information managed by the call control server 521 may be used as the first terminal information at that time. The call control server 521 manages terminal information of IP phone terminals for which a call connection is controlled, retrieves the first terminal information such as an IP address or SIP-URI of the wireless IP phone terminal station 515, managed when the second terminal information is received from the position information notification server 522, and transmits the first terminal information to the position information notification server 522. The second processing section 526 receives the first terminal information from the call control server 521, transmits the first terminal information to the position information management server 512 on the basis of the first address information, receives the first position information from the position information management server 512, and transmits the first position information to the command system in the emergency call receiving organization 503 (position information receiver 532).

The position information notification server 522 has a function, when the position information of the wireless IP phone terminal station 515 corresponding to the first terminal information is requested from the call control server 521, of acquiring the first position information of the wireless IP phone terminal station 515 from the position information management server 512, and sending a reply. The second processing section 526 receives the first terminal information such as an IP address or SIP-URI of the wireless IP phone terminal station 515, from the call control server 521, transmits the first terminal information to the position information management server 512 on the basis of the first address information such as an IP address of position management server 512, receives the first position information from the position information management server 512, and transmits the first position information to the call control server 521. The position information notification server 522 likewise has a function, when the position information of other wireless IP phone terminal stations corresponding to other terminal information is requested from the call control server 521, of acquiring position information of the other wireless IP phone terminal stations from the position information management server 512, and sending a reply. The second processing section 526 receives other terminal information from the call control server 521, transmits the other terminal information to the position information management server on the basis of other address information, receives position information from the position information management server on the basis of the other address information, and transmits this position information to the call control server 521.

Even when the second management section 525 manages a network address managed by the position information management server 512, the first address information may be found, for example, as follows. For example, when the wireless IP phone terminal station 515 is in the access network 501, the first terminal information of the wireless IP phone terminal station 515 is managed by the position information management server 512 which is in the access network 501. At this time, since the wireless IP phone terminal station 511 and position information management server 512 are in the same access network 501, the network address (for example, “aaa.bbb.ccc”) of the IP address (for example, “aaa.bbb.ccc.xxx”) of the IP phone terminal 411 and the network address (for example, “aaa.bbb.ccc”) of the IP address (for example, “aaa.bbb.ccc.zzz”) of the position information management server 412 are the same. Therefore, if the IP address of the IP phone terminal 515 is known, the network address of the position information management server 512 which manages the IP phone terminal 515 is known, and the IP address of the position information management server 512 is known from the network address of the position information management server 512.

Further, the call control server 521 receives a first signal containing the first terminal information such as an IP address or SIP-URI of the IP phone terminal 515, which was transmitted by the IP phone terminal 515. When the call control server 521 determines that the first signal connection is an emergency call by the first device information regarding the command system in the emergency call receiving organization 503 such as an IP address or SIP-URI of the command system in the emergency call receiving organization 503, the call control server 521 transmits the first terminal information of the position information management server 512 to the position information notification server 522. The call control server 521 likewise receives other signals containing other terminal information transmitted by other wireless IP phone terminal stations. When the call control server 521 determines that another signal connection is an emergency call by device information regarding a command system, the call control server 521 transmits other terminal information to the position information notification server 522.

The call control server 521 receives the first position information of the wireless IP phone terminal station 515 transmitted by the position information notification server 522, and transmits the first position information to the connection destination information database 524. The call control server 521 likewise receives the first device information transmitted by the connection destination information database 524, and originates an outgoing call to the command system in the emergency call receiving organization 503 which has jurisdiction over (or is nearest to) the wireless IP phone terminal station 515 on the basis of the first device information. The call control server 521 likewise receives position information of other IP phone terminals transmitted by the position information notification server 522, and transmits the other position information to the connection destination information database 524. The call control server 521 likewise receives other device information transmitted by the connection destination information database 524, and originates an outgoing call to a command system which has jurisdiction over (or is nearest to) another wireless IP phone terminal station on the basis of the other device information.

The command system in the emergency call receiving organization 503 shown in FIG. 8 basically has the same configuration as the command system in the emergency call receiving organization 403 shown in FIG. 6. Referring to FIG. 8, the command system in the emergency call receiving organization 503 includes a command terminal 531 and a position information receiver 532. The command system in the emergency call receiving organization 503 may also include one or more command terminals other than the command terminal 531, but these command terminals are not shown in FIG. 8. The command system in the emergency call receiving organization 503 may also include one or more position information receivers 532 other than the position information receiver 532, but these position information receivers are not shown in FIG. 8. Moreover, there may also be command systems in emergency call receiving organizations in addition to the command system in the emergency call receiving organization 503, but these other command systems are not shown in FIG. 8.

The command terminal 531 shown in FIG. 8 basically has the same configuration as the command terminal 431 shown in FIG. 6, and receives an emergency call from the wireless IP phone terminal station 515 and sends a call back to the wireless IP phone terminal station 515. The position information receiver 532 shown in FIG. 8 basically has the same configuration as the position information receiver 432 shown in FIG. 6, and has functions of acquiring the first position information of the wireless IP phone terminal station 515 and displaying the acquired first position information of the wireless IP phone terminal station 515 on a map. Further, the command terminal 531 likewise receives emergency calls from other wireless IP phone terminal stations, and sends call backs to the other wireless IP phone terminal stations. The position information receiver 532 has functions of acquiring position information of other wireless IP phone terminal stations and displaying the acquired position information of other wireless IP phone terminal stations on a map.

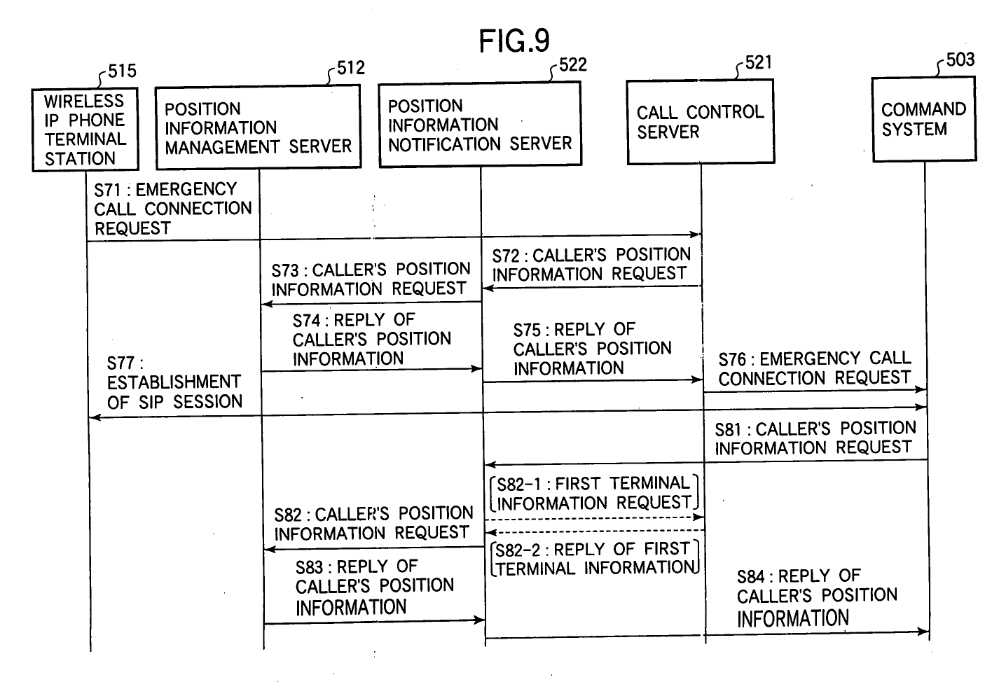

The operation of the fourth embodiment will now be described, referring to FIG. 8 and FIG. 9. The operation of this fourth embodiment will be described where, in the operation of the aforesaid third embodiment, the wireless IP phone terminal station is also connected. Here, the connection to the IP phone terminal 511 is the same as the operation of the aforesaid third embodiment, so only connection to the wireless IP phone terminal station 315 will be described. The basic operation when the wireless IP phone terminal station 515 is connected is the same as the operation when the IP phone terminal 511 shown in FIG. 6 is connected. In addition, steps S71 to S77 and steps S81 to S84 (described later) shown in FIG. 9 correspond to steps S51 to S57 and steps S61 to S64 shown in FIG. 7. Here, two types of operation will be described, i.e., where the authentication server 517 shown in FIG. 8 is used, and where it is not used.

When a connection is made to the wireless IP phone terminal station 515, the wireless access point 516 receives a user ID and a password from the wireless IP phone terminal station 515 according to the authentication procedure defined by IEEE802.1X, and performs authentication of the user of the wireless IP phone terminal station 515 in collaboration with the authentication server 517. When user authentication is complete, the ID of the wireless access point 516 and the user ID of the wireless IP phone terminal station 515 are transmitted to the position information management server 512 as terminal connection messages.

In a case where the authentication server 517 is used, when a connection is made to the wireless IP phone terminal station 515, the wireless access point 516 receives a user ID and a password from the wireless IP phone terminal station 515 according to the authentication procedure defined by IEEE802.1X, and performs authentication of the user of the wireless IP phone terminal station 515 in collaboration with the authentication server 517. When user authentication is complete, the ID of the wireless access point 516 and terminal information of the wireless IP phone terminal station 515 such as an IP address or SIP-UPI of the wireless IP phone terminal station 515 are transmitted to the position information management server 512 as a terminal connection message.

In a case where authentication server 517 is not used, the wireless access point 516, when it connects to the wireless IP phone terminal station 515, transmits the ID of the wireless access point 516 and terminal information of the wireless IP phone terminal station 515 such as an IP address or SIP-UPI of the wireless IP phone terminal station 515 to the position information management server 512 as a terminal connection message.

The position information management server 512 registers position information of the wireless access point 516, which is registered beforehand from the ID of the wireless access point 516 contained in the terminal connection message, as the first position information of the transmitted first terminal information such as an IP address or SIP-URI of the wireless IP phone terminal station 515.

The position information of the wireless access point is registered in the position information management server 512 when the wireless access point 516 is installed or when it is transferred.

Regarding the position information of the wireless access point, alternatively, a position information measurement function such as GPS may be installed in the wireless access point 516 itself, and the position information measured by this position information measurement function registered in the position information management server 512 when the wireless access point is installed or transferred. The position registration may be implemented by including position information of the wireless access point 516 in the connection message for the wireless IP phone terminal station 515, or by having the position information management server 512 inquiry the wireless access point 516 for position information measurement data as required.

Referring to FIG. 8, when the wireless IP phone terminal station 515 originates an emergency call (step S71 in FIG. 9), the call control server 521 requests the position information notification server 522 for position information of the wireless IP phone terminal station 515 as the caller's terminal by a message containing the first terminal information such as an IP address or SIP-UPI of the wireless IP phone terminal station 515 (step S72 in FIG. 9).

The position information notification server 522, in which the first terminal information of the wireless IP phone terminal station 515 and the first address information of the position information management server 512 are registered beforehand so as to correspond to each other, specifies the first address information of the position information management server 512 from the first terminal information of the wireless IP phone terminal station 515, and requests the position information of the wireless IP phone terminal station 515 as the caller's terminal by a message containing the aforesaid first terminal information (step S73 in FIG. 9).

The position information management server 512 retrieves the first terminal information of the wireless IP phone terminal station 515 managed by the aforesaid method, and returns the requested first position information of the wireless IP phone terminal station 515 corresponding to the first terminal information (step S74 in FIG. 9).

The position information notification server 522 returns the acquired first position information to the call control server 521 (step S75 in FIG. 9), and the call control server 521 acquires the first device information of the command system in the emergency call receiving organization 503 such as an IP address or SIP-URI of the command terminal 531 of the command system in the emergency call receiving organization 503, corresponding to the first position information from the connection destination information database 514.

The call control server 521 then makes an emergency call connection request to the command system in the emergency call receiving organization 503 (step S76 in FIG. 9), and establishes a call connection between the wireless IP phone terminal station 515 and the command system in the emergency call receiving organization 503 (step S77 in FIG. 9).

When the command system in the emergency call receiving organization 203 desires to check the position information of the wireless IP phone terminal station 515 as the caller's terminal, by the command system in the emergency call receiving organization 503, the first position information of the wireless IP phone terminal station 515 is requested by the position information notification server 522 from the position information receiver 532 by a message containing the first terminal information of the wireless IP phone terminal station 515 step S81 in FIG. 9). In this case, the position information notification server 522 issues an inquiry to the position information management server 512 as in steps S73 and S74 for the first position information of the wireless IP phone terminal station 515 (step S82 in FIG. 9), the position information management server 512 returns the first position information of the wireless IP phone terminal station 515 (step S83 in FIG. 9), and the position information notification server 522 returns this acquired first position information to the position information receiver 532 (step S84 in FIG. 9).

When requesting the first position information of the wireless IP phone terminal station 515 as the caller's terminal, from the command system in the emergency call receiving organization 503, the first terminal information of the wireless IP phone terminal station 515 may be input to the position information receiver 532 by an operator who checks the information via a GUI of the command terminal 531, or by automatic acquisition from the command terminal 531.

Next, in the operation of the fourth embodiment, an operation example, Case D1, will be described where the command system in the emergency call receiving organization 503, as the first terminal information of the wireless IP phone terminal station 515, knows an SIP-URI (the second terminal information) of the wireless IP phone terminal station 515, the position information notification server 522 manages the network addresses managed by the position information management server 512, and manages correspondence information of the position information management server 512 (steps S81 to S84 in FIG. 9). Another operation example, Case D2, will also be described where an IP address or SIP-URI (the second terminal information) of the wireless IP phone terminal station 515 are known, the position information notification server 522 manages the network addresses managed by the position information management server 512, and manages correspondence information of the position information management server 512 (steps S81 to S84 in FIG. 9). In Cases D1 and D2, as an example, the situation is shown where, in the second processing section 526, when the second terminal information held by the command system in the emergency call receiving organization 503 (IP address or SIP-UPI of the wireless IP phone terminal station 515) is received, the second terminal information is transmitted to the call control server 521, and the terminal information managed by the call control server 521 at that time is used as the first terminal information.

(Case D1)

In step 81 in FIG. 9, when the command system in the emergency call receiving organization 503 desires to check the position information of the IP phone terminal 515 as the caller's terminal, the position information receiver 532 requests the position information notification server 522 for the first position information of the wireless IP phone terminal station 515 as the caller's terminal by using a message containing the SIP-URI which is the second terminal information of the wireless IP phone terminal station 515 as the caller's terminal.

The position information notification server 522 transmits the SIP-URI which is the second terminal information of the IP phone terminal 515 to the call control server 521 (step S82-1 in FIG. 9). The call control server 521, when the wireless IP phone terminal station 515 is calling/talking, manages an SIP-URI, an IP address and the like, which are the first terminal information of the wireless IP phone terminal station 515, or knows where to get an SIP-URI, an IP address and the like. Therefore, the call control server 521 retrieves an IP address which is the first terminal information of the present wireless IP phone terminal station 515, from the SIP-URI which is the received second terminal information of the wireless IP phone terminal station 515. The call control server 521 transmits the IP address which is the retrieved first terminal information to the position information notification server 522 (step S82-2 in FIG. 9).

The network address managed by the position information management server 512 and the IP address which is the first address information of the position information management server 512 are registered beforehand in the position information notification server 522 so as to correspond to each other. The position information notification server 522 retrieves a corresponding network address from the received IP address which is the first terminal information, and specifies the IP address of the position information management server 512 from the retrieved network address. The position information notification server 522 requests the specified position information management server 512 for the position information of the wireless IP phone terminal station 515 as the caller's terminal by a message containing the IP address which is the first terminal information.

Here, as an example, let the network address in the IP address which is the first terminal information and the network address managed by the position information management server 512 be “aaa.bbb.ccc”, the IP address which is the first terminal information of the wireless IP phone terminal station 515 be “aaa.bbb.ccc.yyy”, and the IP address of the position information management server 512 be “aaa.bbb.ccc.zzz”. Let the network address managed by other position information management servers be “aaa.bbb.ddd”, and the IP addresses of other position information management servers be “aaa.bbb.ccc.zzz”. When the wireless IP phone terminal station 515 has moved to another access network, the wireless IP phone terminal station 515 is registered in another position information management server, so the IP address of the wireless IP phone terminal station 515 at this time will be “aaa.bbb.ddd.yyy”, and the network address in the IP address which is the first terminal information will be “aaa.bbb.ddd”.

In step S83 in FIG. 9, the position information management server 512 retrieves the IP address which is the first terminal information of the wireless IP phone terminal station 515 managed by the aforesaid method, and returns the first position information of the wireless IP phone terminal station 515 corresponding to the requested IP address to the position information notification server 522. At this time, if the wireless IP phone terminal station 515 is in the access network 501, the IP address for the wireless IP phone terminal station 515 is aaa.bbb.ccc.yyy”. If the wireless IP phone terminal station 515 moves from the access network 501 to another access network and is in another access network, the IP address for the wireless IP phone terminal station 515 is “aaa.bbb.ddd.yyy”.

In step S84 in FIG. 9, the position information notification server 522 acquires the first position information of the wireless IP phone terminal station 515 as the caller's terminal, and returns this first position information to the position information receiver 532.

(Case D2)

In step 81 in FIG. 9, when the command system in the emergency call receiving organization 503 desires to check the position information of the wireless IP phone terminal station 515 as the caller's terminal, the position information receiver 532 requests the position information notification server 522 for the first position information of the wireless IP phone terminal station 515 as the caller's terminal by using a message containing the IP address and the SIP-URI which are the second terminal information of the wireless IP phone terminal station 515 as the caller's terminal.

The network address managed by the position information management server 512 and the IP addresses which is the first address information of the position information management server 51-2 are registered beforehand in the position information notification server 522 so as to correspond to each other. The position information notification server 522 retrieves a corresponding network address from the received IP address which is the second terminal information, and specifies the IP address of the position information management server 512 from the retrieved network address. The position information notification server 522 requests the specified position information management server 512 for the position information of the wireless IP phone terminal station 515 as the caller's terminal by a message containing the IP address which is the first terminal information.

Here, as an example, let the network address in the IP address which is the first terminal information and the network address managed by the position information management server 512 be aaa.bbb.ccc”, the IP address which is the first terminal information of the wireless IP phone terminal station 515 be “aaa.bbb.ccc.yyy”, and the IP address of the position information management server 512 be “aaa.bbb.ccc.zzz”. Let the network address managed by other position information management server be “aaa.bbb.ddd”, and the IP address of other position information management server be “aaa.bbb.ccc.zzz”. When the wireless IP phone terminal station 515 is moved to another access network, the wireless IP phone terminal station 515 is registered in another position information management server, so the IP address of the wireless IP phone terminal station 515 at this time will be “aaa.bbb.ddd.yyy”, and the network address in the IP address which is the first terminal information will be “aaa.bbb.ddd”.

In step S83 in FIG. 9, when the IP address which is the second terminal information is equal to the IP address which is the first terminal information, the position information management server 512 retrieves the IP address which is the first terminal information of the wireless IP phone terminal station 515 managed by the aforesaid method, and returns the first position information of the wireless IP phone terminal station 515 corresponding to the requested IP address to the position information notification server 522. At this time, if the IP address which is the second terminal information of the IP phone terminal is “aaa.bbb.ccc.yyy” and the wireless IP phone terminal station 515 is in the access network 501, the IP address which is the first terminal information of the wireless IP phone terminal station 515 is “aaa.bbb.ccc.yyy”.

In step S84 in FIG. 9, the position information notification server 522 acquires the first position information of the wireless IP phone terminal station 515 as the caller's terminal, and returns this first position information to the position information receiver 532.

However, although the IP address which is the second terminal information of the wireless IP phone terminal station 515 is “aaa.bbb.ccc.yyy”, if the wireless IP phone terminal station 515 is moved from the access network 501 to another access network and is in another access network, the IP address which is the first terminal information of the wireless IP phone terminal station 515 is “aaa.bbb.ddd.yyy”. At this time, the first position information of the wireless IP phone terminal station 515 cannot be acquired from the position information management server 512, so this is performed using the SIP-URI which is the second terminal information of the wireless IP phone terminal station 515 by the similar procedure described in the aforesaid Case D1 and shown in steps S82 to S84 in FIG. 9.

The position information notification server 522 transmits the SIP-URI which is the second terminal information of the wireless IP phone terminal station 515 to the call control server 521 (step S82-1 in FIG. 9). The call control server 521, when the wireless IP phone terminal station 515 is calling/talking, manages the SIP-URI, the IP address and the like, which are the first terminal information of the wireless IP phone terminal station 515, or knows where to get the SIP-URI, the IP address and the like. Therefore, the call control server 521 retrieves the IP address which is the first terminal information of the present wireless IP phone terminal station 515, from the SIP-URI which is the received second terminal information of the wireless IP phone terminal station 515. The call control server 521 transmits the IP address which is the retrieved first terminal information to the position information notification server 522 (step S82-2 in FIG. 9).

The network address managed by the position information management server 512 and the IP addresses which is the first address information of the position information management server 512 are registered beforehand in the position information notification server 522 so as to correspond to each other. The position information notification server 522 retrieves a corresponding network address from the received IP address which is the first terminal information, and specifies the IP address of the position information management server 512 from the retrieved network address. The position information notification server 522 requests the specified position information management server 512 for the position information of the wireless IP phone terminal station 515 as the caller's terminal by a message containing the IP address which is the first terminal information.

In step S83 in FIG. 9, the position information management server 512 retrieves the IP address which is the first terminal information of the wireless IP phone terminal station 515 managed by the aforesaid method, and returns the first position information of the wireless IP phone terminal station 515 corresponding to the requested IP address which is the first terminal information to the position information notification server 522. Since the wireless IP phone terminal station 515 moves from the access network 501 to another access network and is in another access network at this time, the IP address which is the first terminal information of the wireless IP phone terminal station 515 is “aaa.bbb.ddd.yyy”.

In step S84 in FIG. 9, the position information notification server 522 acquires the first position information of the wireless IP phone terminal station 515 as the caller's terminal, and returns this first position information to the position information receiver 532.

Although the SIP-URI which is the second terminal information was not shown in steps S82, S82-2m S83 and S84 in FIG. 9, the SIP-URI which is the second terminal information may be transmitted/received in each step.

In the above, when the position information management server 512 is installed in a different network separated by a NAT function or the like, the wireless IP phone terminal station 515 uses a global IP address when transmitting to/receiving from the VoIP network 502. Therefore, in this case, a global IP address may be used as the first terminal information of the wireless IP phone terminal station 515.

According to the emergency call system or the emergency call method of the fourth embodiment, it is possible to obtain an advantage, in addition to the advantage of the first embodiment, even when the third information or the network address managed by the position information management server is used as information about the IP phone terminal, and even when the terminal is a wireless terminal station and moves to a different service area, the position information management device is specified from the address information of the terminal when the phone call is made, so the present position information of the terminal can be acquired.

The invention being thus described, it will be obvious that the same may be varied in many ways. Such variations are not to be regarded as a departure from the spirit and scope of the invention, and all such modifications as would be obvious to one skilled in the art are intended to be included within the scope of following claims.

What is claimed is:

1. An emergency call system comprising:
a position information management device; and
a position information notification device;
wherein the position information management device includes:
a first management section which manages first terminal information of a terminal and first position information of the terminal, and
a first processing section which receives the first terminal information transmitted from the position information notification device, and transmits the first position information to the position information notification device;
wherein the position information notification device includes:
a second management section which manages the first terminal information and first address information of the position information management device, and
a second processing section which receives the first terminal information from a first device, transmits the first terminal information of the position information management device on the basis of the first address information, receives the first position information from the position information management device, and transmits the first position information to the first device.

2. The emergency call system according to claim 1, wherein the position information management device, the position information notification device and the first device are connected to an IP phone network.

3. The emergency call system according to claim 1, wherein the first device is a command system placed in an emergency call receiving organization.

4. The emergency call system according to claim 1, wherein the first device is a call control device which controls a call connection between the terminal and a command system placed in an emergency call receiving organization.

5. The emergency call system according to claim 4, further comprising:
a third management section which manages second position information of the command system and first device information of the command system; and
a third processing section which receives first position information transmitted from the call connection device, retrieves the second position information corresponding to the first position information, and transmits the first device information;
wherein when the call connection device receives a first signal containing the first terminal information transmitted by the terminal and determines that the first signal is an emergency call, the call connection device
transmits the first terminal information to the position information notification device,
receives the first position information transmitted by the position information notification device,
transmits the first position information to a third management section,
receives the first device information transmitted by the third management section, and
originates an outgoing call to the command system on the basis of the first device information.

6. The emergency call system according to claim 1, wherein the first position information is registered on the basis of a position of an installed terminal.

7. The emergency call system according to claim 1, wherein the terminal is a wireless terminal station, and the first position information is notified from a wireless access point to which the terminal can connect.

8. The emergency call system according to claim 1, wherein the terminal is a wireless terminal station, and the first position information includes position information on the wireless access point, or position information measured by a position information measurement function with which the wireless access point is provided.

9. The emergency call system according to claim 1, wherein the terminal is a wireless terminal station, and a time when the position information management device registers the first position information is a time when the terminal connects to a wireless access point.

10. The emergency call system according to claim 1, wherein, when the terminal is a wireless terminal station, the timing at which the position information management device registers the first position information is taken as the time when the terminal moves between wireless access points, and re-connects.

11. The emergency call system according to claim 1, wherein the terminal is a wireless terminal station, and a time when the position information management device deletes the position information is a time when a connection with a wireless access point is terminated.

12. An emergency call method using a position information management device and a position information notification device, comprising the steps of:
causing the position information management device to manage first terminal information of a terminal and first position information of the terminal; and
causing the position information management device to receive the first terminal information transmitted from the first position information notification device and to transmit the first position information to the position information notification device;
causing the position information notification device to manage the first terminal information and first address information of the position information management device; and
causing the position information notification device to receive the first terminal information from the first terminal, to transmit the first terminal information to the position information management device on the basis of the first address information, to receive the first position information from the position information management device, and to transmit the first position information to a first device.

13. An emergency call system comprising:
a position information management device;
a call control device; and
a position information notification device;
wherein the position information management device includes:
a first management section which manages the first terminal information of a terminal and the first position information of the terminal, and
a first processing section which receives the first terminal information transmitted from the position information notification device, and transmits the first position information to the position information notification device;
wherein the call control device retrieves the first terminal information from a received second terminal information of the terminal, and transmits the retrieved first terminal information;
wherein the position information notification device includes:
a second management section which manages the first terminal information and first address information of the position information management device, and
a second processing section which receives the second terminal information from a command system placed in an emergency call receiving organization, transmits the second terminal information to the call control device, receives the first terminal information from the call control device, transmits the first terminal information to the position information management device on the basis of the first address information, receives the first position information from the position information management device, and transmits the first position information to a first device.

14. An emergency call system comprising:
a position information management device; and
a position information notification device;
wherein the position information management device includes:
a first management section which manages first terminal information of a terminal and first position information of the terminal; and
a first processing section which receives the first terminal information transmitted from the position information notification device, and transmits the first position information to the position information notification device; and
wherein the position information notification device includes:
a second management section which manages network address information of first address information of the position information management device, and the first address information of the position information management device; and
a second processing section which receives first terminal information from a command system placed in an emergency call receiving organization, retrieves the network address information of the first address information which indicates with a network address of the first terminal information, transmits the first terminal information to the position information management device on the basis of the retrieved address information, receives the first position information from the position information management device, and transmits the first position information to a first device.

15. An emergency call method using a position information management device, a call control device, and a position information notification device, comprising the steps of:
causing the position information management device to manage first terminal information of a terminal and first position information of the terminal;
causing the position information management device to receive the first terminal information transmitted from the first position information notification device and to transmit the first position information to the position information notification device;
causing the call control device to retrieve the first terminal information from a received second terminal information and to transmit the retrieved first terminal information;
causing the position information notification device to manage the first terminal information and first address information of the position information management device; and
causing the position information notification device to receive the second terminal information from a command system placed in an emergency call receiving organization, transmits the second terminal information to the call control device, to receive the first terminal information from the call control device, to transmit the first terminal information to the position information management device on the basis of the first address information, to receive the first position information from the position information management device, and to transmit the first position information to a first device.

16. An emergency call method using a position information management device and a position information notification device, comprising:
causing the position information management device to manage first terminal information of a terminal and first position information of the terminal;
causing the position information management device to receive the first terminal information transmitted from the position information notification device and to transmit the first position information to the position information notification device;
causing the position information notification device to manage the first terminal information and first address information of the position information management device; and
causing the position information notification device to receive a second terminal information from a command system placed in an emergency call receiving organization, to transmit the first terminal information to the position information management device on the basis of the first address information, to receive the first position information from the position information management device, and to transmit the first position information to a first device.
